(19) United States
(12) Patent Application Publication
(10) Pub. No.: US 2026/0006551 A1
(43) Pub. Date: Jan. 1, 2026

(54) LOCATION UPDATES FOR PAGING MONITORING

(71) Applicant: QUALCOMM Incorporated, San Diego, CA (US)

(72) Inventors: Changhwan PARK, San Diego, CA (US); Navid ABEDINI, Basking Ridge, NJ (US); Naeem AKL, Bridgewater, NJ (US)

(21) Appl. No.: 18/756,201

(22) Filed: Jun. 27, 2024

(51) Int. Cl. H04W 52/02; H04W 68/02

(52) U.S. Cl. CPC H04W 52/0235; H04W 52/0212; H04W 68/02

(57) ABSTRACT

Methods, systems, and devices for wireless communications are described. A user equipment (UE) may receive, via a first cell and while operating in an idle mode, a message including information about one or more other cells in a coverage area of the first cell that may be configured with a network energy savings mode. The UE may transmit, upon transitioning to a second cell in the coverage area of the first cell, an on-demand system information request including a unique identifier for the UE. The UE may receive, via the second cell, a message including system information and an indication of resources dedicated for the UE. The UE may monitor, based on the on-demand system information request, a paging channel associated with a first synchronization signal block identifier of the second cell for one or more paging messages. The UE may transmit a location update message via the dedicated resources.

### FIELD OF TECHNOLOGY

The following relates to wireless communications, including location updates for paging monitoring.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving, via a first cell and while operating in an idle mode, a message including information about one or more other cells in a coverage area of the first cell, where one or more other cells in the coverage area are configured with a network energy savings mode, transmitting, upon transitioning to a second cell in the coverage area of the first cell, an on-demand system information request including a unique identifier for the UE, receiving, via the second cell, a message including system information, and monitoring, based on the on-demand system information request, a paging channel associated with a first synchronization signal block (SSB) identifier of the second cell for one or more paging messages.

A UE for wireless communications is described. The UE may include one or more memories storing processor executable code, and one or more processors coupled with the one or more memories. The one or more processors may individually or collectively be operable to execute the code to cause the UE to receive, via a first cell and while operating in an idle mode, a message including information about one or more other cells in a coverage area of the first cell, where one or more other cells in the coverage area are configured with a network energy savings mode, transmit, upon transitioning to a second cell in the coverage area of the first cell, an on-demand system information request including a unique identifier for the UE, receive, via the second cell, a message including system information, and monitor, based on the on-demand system information request, a paging channel associated with a first SSB identifier of the second cell for one or more paging messages.

Another UE for wireless communications is described. The UE may include means for receiving, via a first cell and while operating in an idle mode, a message including information about one or more other cells in a coverage area of the first cell, where one or more other cells in the coverage area are configured with a network energy savings mode, means for transmitting, upon transitioning to a second cell in the coverage area of the first cell, an on-demand system information request including a unique identifier for the UE, means for receiving, via the second cell, a message including system information, and means for monitoring, based on the on-demand system information request, a paging channel associated with a first SSB identifier of the second cell for one or more paging messages.

A non-transitory computer-readable medium storing code for wireless communications is described. The code may include instructions executable by one or more processors to receive, via a first cell and while operating in an idle mode, a message including information about one or more other cells in a coverage area of the first cell, where one or more other cells in the coverage area are configured with a network energy savings mode, transmit, upon transitioning to a second cell in the coverage area of the first cell, an on-demand system information request including a unique identifier for the UE, receive, via the second cell, a message including system information, and monitor, based on the on-demand system information request, a paging channel associated with a first SSB identifier of the second cell for one or more paging messages.

Some examples of the method, UEs, and non-transitory computer-readable medium described herein may further include operations, features, means, or instructions for receiving an indication of one or more resources for a location update message, the one or more resources dedicated for the UE and associated with at least a second SSB identifier of the second cell, transmitting, via the one or more resources, the location update message based on transitioning from a first location associated with the first SSB identifier of the second cell to a second location associated with the second SSB identifier of the second cell, and monitoring, based on the location update message, a paging channel associated with the second SSB identifier for one or more paging messages.

In some examples of the method, UEs, and non-transitory computer-readable medium described herein, the one or more resources may be associated with a dedicated remote access point identifier (RAPID).

In some examples of the method, UEs, and non-transitory computer-readable medium described herein, the one or more resources include two or more adjacent transmission beams, each adjacent transmission beam associated with a respective SSB identifier.

Some examples of the method, UEs, and non-transitory computer-readable medium described herein may further include operations, features, means, or instructions for receiving an indication of whether the location update message may be associated with a system information request, an SSB request, or a random access channel request, where transmitting the location update message may be based on the indication.

In some examples of the method, UEs, and non-transitory computer-readable medium described herein, the unique identifier for the UE may be a temporary mobile subscriber identifier (TMSI) or an inactive radio network temporary identifier (I-RNTI) based on a radio resource control (RRC) mode of the UE.

In some examples of the method, UEs, and non-transitory computer-readable medium described herein, the on-demand system information request includes an on-demand system information block 1 (OD-SIB1), an on-demand other system information (OD-OSI), an SSB, or a random access channel (RACH).

A method for wireless communications by an apparatus is described. The method may include outputting, via a first cell, a message including information about one or more other cells in a coverage area of the first cell, where one or more other cells in the coverage area are configured with a network energy savings mode, obtaining, from a UE and via a second cell in the coverage area, an on-demand system information request including a unique identifier for the UE, outputting, via the second cell, a message including system information, and outputting, via a first paging channel associated with a first SSB identifier of the second cell, one or more paging messages based on the on-demand system information request.

An apparatus for wireless communications is described. The apparatus may include one or more memories storing processor executable code, and one or more processors coupled with the one or more memories. The one or more processors may individually or collectively be operable to execute the code to cause the apparatus to output, via a first cell, a message including information about one or more other cells in a coverage area of the first cell, where one or more other cells in the coverage area are configured with a network energy savings mode, obtain, from a UE and via a second cell in the coverage area, an on-demand system information request including a unique identifier for the UE, output, via the second cell, a message including system information, and output, via a first paging channel associated with a first SSB identifier of the second cell, one or more paging messages based on the on-demand system information request.

Another apparatus for wireless communications is described. The apparatus may include means for outputting, via a first cell, a message including information about one or more other cells in a coverage area of the first cell, where one or more other cells in the coverage area are configured with a network energy savings mode, means for obtaining, from a UE and via a second cell in the coverage area, an on-demand system information request including a unique identifier for the UE, means for outputting, via the second cell, a message including system information, and means for outputting, via a first paging channel associated with a first SSB identifier of the second cell, one or more paging messages based on the on-demand system information request.

A non-transitory computer-readable medium storing code for wireless communications is described. The code may include instructions executable by one or more processors to output, via a first cell, a message including information about one or more other cells in a coverage area of the first cell, where one or more other cells in the coverage area are configured with a network energy savings mode, obtain, from a UE and via a second cell in the coverage area, an on-demand system information request including a unique identifier for the UE, output, via the second cell, a message including system information, and output, via a first paging channel associated with a first SSB identifier of the second cell, one or more paging messages based on the on-demand system information request.

Some examples of the method, apparatus, and non-transitory computer-readable medium described herein may further include operations, features, means, or instructions for outputting an indication of one or more resources for a location update message, the one or more resources dedicated for the UE and associated with at least a second SSB identifier of the second cell, obtaining, via the one or more resources associated with the second SSB identifier, the location update message, and outputting, based on the location update message and via a second paging channel associated with the second SSB identifier, one or more paging messages for the UE.

Some examples of the method, apparatus, and non-transitory computer-readable medium described herein may further include operations, features, means, or instructions for refraining from outputting one or more paging messages via the first paging channel associated with the first SSB identifier based on the location update message.

In some examples of the method, apparatus, and non-transitory computer-readable medium described herein, the one or more resources may be associated with a dedicated RAPID.

In some examples of the method, apparatus, and non-transitory computer-readable medium described herein, the one or more resources include two or more adjacent transmission beams, each adjacent transmission beam associated with a respective SSB identifier.

Some examples of the method, apparatus, and non-transitory computer-readable medium described herein may further include operations, features, means, or instructions for outputting an indication of whether the location update message may be associated with a system information request, an SSB request, or a random access channel request, where obtaining the location update message may be based on the indication.

In some examples of the method, apparatus, and non-transitory computer-readable medium described herein, the unique identifier for the UE may be a TMSI or an I-RNTI based on an RRC mode of the UE.

In some examples of the method, apparatus, and non-transitory computer-readable medium described herein, the on-demand system information request includes an OD-SIB1, an OD-OSI, an SSB, or a RACH.

A method for wireless communications by an apparatus is described. The method may include obtaining, from a UE, a message that requests system information and identifies the UE via a UE identifier, generating, based on a trigger condition, a paging message for the UE, and outputting, to the UE while the UE is in an idle mode, the paging message via a paging channel associated with a first SSB identifier associated with a first cell of a set of multiple cells.

An apparatus for wireless communications is described. The apparatus may include one or more memories storing processor executable code, and one or more processors coupled with the one or more memories. The one or more processors may individually or collectively be operable to execute the code to cause the apparatus to obtain, from a UE, a message that requests system information and identifies the UE via a UE identifier, generate, based on a trigger condition, a paging message for the UE, and output, to the UE while the UE is in an idle mode, the paging message via a paging channel associated with a first SSB identifier associated with a first cell of a set of multiple cells.

Another apparatus for wireless communications is described. The apparatus may include means for obtaining, from a UE, a message that requests system information and identifies the UE via a UE identifier, means for generating, based on a trigger condition, a paging message for the UE, and means for outputting, to the UE while the UE is in an idle mode, the paging message via a paging channel associated with a first SSB identifier associated with a first cell of a set of multiple cells.

A non-transitory computer-readable medium storing code for wireless communications is described. The code may include instructions executable by one or more processors to obtain, from a UE, a message that requests system information and identifies the UE via a UE identifier, generate, based on a trigger condition, a paging message for the UE, and output, to the UE while the UE is in an idle mode, the paging message via a paging channel associated with a first SSB identifier associated with a first cell of a set of multiple cells.

Some examples of the method, apparatus, and non-transitory computer-readable medium described herein may further include operations, features, means, or instructions for forwarding the message, assistance information, or both to a network entity and obtaining, from the network entity and based on forwarding the message, instructions to page the UE via the first cell of the set of multiple cells, where outputting the paging message may be based on the instructions.

In some examples of the method, apparatus, and non-transitory computer-readable medium described herein, the assistance information includes cell identifier information, coverage area information, beam information, timing information associated with the message that requests system information, or a combination thereof.

Some examples of the method, apparatus, and non-transitory computer-readable medium described herein may further include operations, features, means, or instructions for storing the UE identifier identifying the UE, assistance information, or both and obtaining, from a network entity, instructions to page the UE via the first cell of the set of multiple cells, where outputting the paging message may be based on the instructions and based on the stored UE identifier.

In some examples of the method, apparatus, and non-transitory computer-readable medium described herein, receiving instructions from the network entity may include operations, features, means, or instructions for obtaining, from the network entity, an indication of a set of multiple cells in a coverage area, where outputting the paging message may be based on the indication of the set of multiple cells and based on a cell identifier associated with the UE identifier.

In some examples of the method, apparatus, and non-transitory computer-readable medium described herein, the assistance information includes cell identifier information, coverage area information, beam information, timing information associated with the message that requests system information, or a combination thereof.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports location updates for paging monitoring in accordance with one or more aspects of the present disclosure.

FIG. 2 shows an example of a wireless communications system that supports location updates for paging monitoring in accordance with one or more aspects of the present disclosure.

FIG. 3 shows an example of a process flow that supports location updates for paging monitoring in accordance with one or more aspects of the present disclosure.

FIG. 4 shows an example of a signaling diagram that supports location updates for paging monitoring in accordance with one or more aspects of the present disclosure.

FIG. 5 shows an example of a signaling diagram that supports location updates for paging monitoring in accordance with one or more aspects of the present disclosure.

FIG. 6 shows an example of a process flow that supports location updates for paging monitoring in accordance with one or more aspects of the present disclosure.

FIGS. 7 and 8 show block diagrams of devices that support location updates for paging monitoring in accordance with one or more aspects of the present disclosure.

FIG. 9 shows a block diagram of a communications manager that supports location updates for paging monitoring in accordance with one or more aspects of the present disclosure.

FIG. 10 shows a diagram of a system including a device that supports location updates for paging monitoring in accordance with one or more aspects of the present disclosure.

FIGS. 11 and 12 show block diagrams of devices that support location updates for paging monitoring in accordance with one or more aspects of the present disclosure.

FIG. 13 shows a block diagram of a communications manager that supports location updates for paging monitoring in accordance with one or more aspects of the present disclosure.

FIG. 14 shows a diagram of a system including a device that supports location updates for paging monitoring in accordance with one or more aspects of the present disclosure.

FIGS. 15 through 21 show flowcharts illustrating methods that support location updates for paging monitoring in accordance with one or more aspects of the present disclosure.

### DETAILED DESCRIPTION

To save energy, a user equipment (UE) may enter an idle or inactive mode in which the UE may wake up periodically to monitor for paging messages. In some examples, the UE may wake up and request system information (e.g., a system information block 1 (SIB1)) from a network entity (e.g., via a message 1 (msg1) or message A (msgA)). However, if an identifier (ID) of the UE is unknown to the network entity, the network entity may blindly transmit a paging message for the UE via one or more cells (e.g., network energy saving (NES) cells that may power down when no active UEs are within the cell) without knowing if the UE is camped on a particular cell. Additionally, or alternatively, if a synchronization signal block (SSB) ID associated with a paging occasion in which the UE monitors for paging occasions is unknown to an NES cell, the NES cell may transmit paging messages for the UE over multiple SSB IDs, including one or more SSB IDs that the UE does not monitor. Methods to reduce signaling and save energy at the network and at the UE may be desired.

In some implementations, a UE may receive, via a first cell and while operating in an idle mode, a message including information about one or more other cells in a coverage area of the first cell (e.g., NES cells that have energy saving capability). The UE may transition to a second cell in the coverage area of the first cell and transmit an on-demand system information request including a unique UE ID. In response to the on-demand system information request, the UE may receive, via the second cell, a message including system information (e.g., a SIB1). The UE may monitor a paging channel associated with a first SSB ID of the second cell for one or more paging messages based on the on-demand system information request. In some examples, the UE may receive (e.g., via the message including system information) an indication of one or more dedicated resources for a location update message. The one or more resources may be associated with a second SSB ID of the second cell. The UE may transmit, via the one or more resources, the location update message based on transitioning from a first location associated with the first SSB ID to a second location associated with the second SSB ID. The UE may monitor a paging channel associated with the second SSB ID for one or more paging messages based on the location update message.

In some examples, a network entity (e.g., a central unit (CU), a distributed unit (DU), a gNB) may forward the message including the system information request, the UE ID, assistance information (e.g., cell ID information, coverage area information, beam information, timing information), or a combination thereof to a higher layer entity or component (e.g., a CU, an access and mobility management function (AMF)) and obtain an instruction to output a paging message for the UE. In some examples, the network entity may store (e.g., cache) the message and obtain instructions to page the UE.

Particular aspects of the subject matter described herein may be implemented to realize one or more potential advantages. The described techniques may provide for reduced processing, improved user experience related to reduced processing, reduced power consumption, reduced latency, more efficient utilization of communication resources, improved coordination between devices, and longer battery life. For example, based on obtaining a unique UE ID associated with an on-demand system information request message, a location update message, or both, a network entity may refrain from outputting one or more paging messages for a first UE to one or more other UEs in the coverage area of the network entity via one or more cells operating in a network energy savings mode. Additionally, or alternatively, the one or more cells may refrain from outputting one or more paging messages for the first UE via an entire SSB ID coverage, and may output the one or more paging messages exclusively to the paging occasions in which the first UE monitors for the one or more paging messages. Similarly, the first UE may refrain from monitoring for one or more paging messages for the one or more other UEs. By using one or more dedicated resources to transmit a location update message, the UE may transmit a relatively smaller payload for the location update message (e.g., excluding the UE ID, because the network knows the identity of the UE based on the dedicated resources used).

Aspects of the disclosure are initially described in the context of wireless communications systems. Aspects of the disclosure and further described in the context of signaling diagrams and process flows. Aspects of the disclosure are further illustrated by and described with reference to apparatus diagrams, system diagrams, and flowcharts that relate to location updates for paging monitoring.

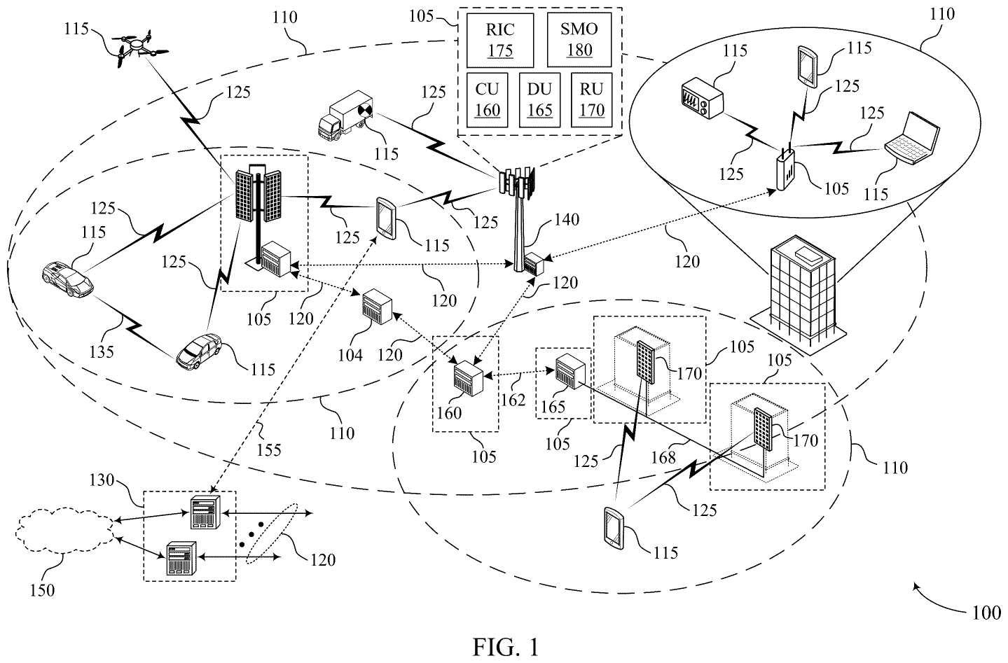

FIG. 1 shows an example of a wireless communications system 100 that supports location updates for paging monitoring in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

To save energy, a UE 115 may enter an idle or inactive mode in which the UE 115 may wake up periodically to monitor for paging messages over a communication link 125. In some examples, the UE 115 may wake up and request system information (e.g., a SIB1) from a network entity 105 (e.g., via a msg1 or msgA over a communication link 125). However, if an identifier (ID) of the UE 115 is unknown to the network entity 105, the network entity 105 may blindly transmit a paging message for the UE 115 via one or more cells (e.g., network energy saving (NES) cells that may power down when no active UEs 115 are within the cell) without knowing if the UE 115 is camped on a particular cell. Additionally, or alternatively, if an SSB ID associated with a paging occasion in which the UE 115 monitors for paging occasions is unknown to an NES cell, the NES cell may transmit paging messages for the UE 115 over multiple SSB IDs, including one or more SSB IDs that the UE 115 does not monitor. Methods to reduce signaling and save energy at the network entity 105 and at the UE 115 may be desired.

In some implementations, a UE 115 may receive, via a first cell and while operating in an idle mode, a message including information about one or more other cells in a coverage area of the first cell (e.g., NES cells that have energy saving capability). The UE 115 may transition to a second cell in the coverage area of the first cell and transmit an on-demand system information request including a unique UE ID. In response to the on-demand system information request, the UE 115 may receive, via the second cell, a message including system information (e.g., a SIB1). The UE 115 may monitor a paging channel associated with a first SSB ID of the second cell for one or more paging messages based on the on-demand system information request. In some examples, the UE 115 may receive (e.g., via the message including system information) an indication of one or more dedicated resources for a location update message. The one or more resources may be associated with a second SSB ID of the second cell. The UE 115 may transmit, via the one or more resources, the location update message based on transitioning from a first location associated with the first SSB ID to a second location associated with the second SSB ID. The UE 115 may monitor a paging channel associated with the second SSB ID for one or more paging messages based on the location update message.

In some examples, a network entity 105 (e.g., a CU 160, a DU 165, a gNB as part of a base station 140) may forward the message including the system information request, the UE ID, assistance information (e.g., cell ID information, coverage area information, beam information, timing information), or a combination thereof to a higher layer (e.g., a CU 160, an AMF included in a core network 130) and obtain an instruction to output a paging message for the UE 115. In some examples, the network entity 105 may store (e.g., cache) the message and obtain instructions to page the UE 115.

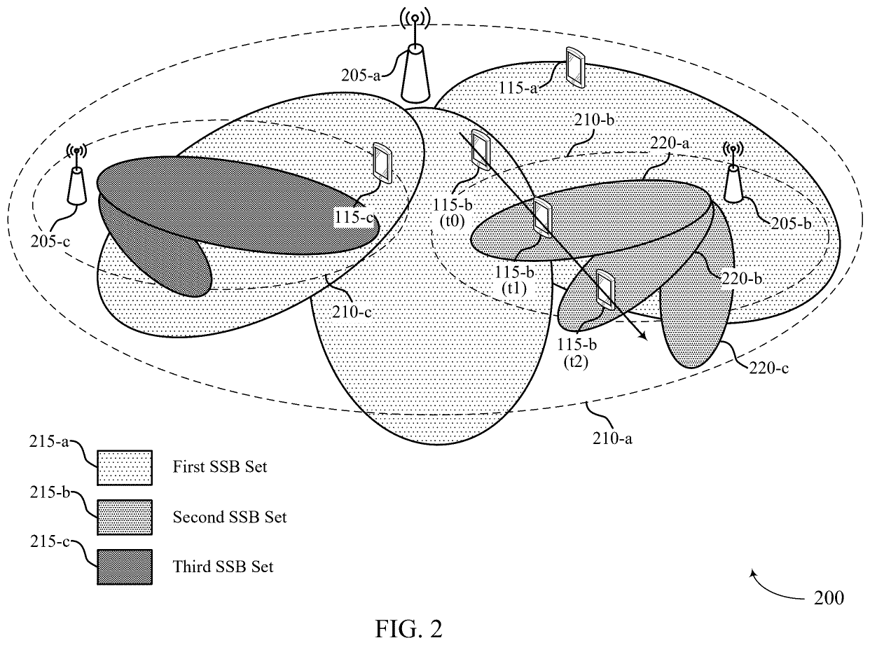

FIG. 2 shows an example of a wireless communications system 200 that supports location updates for paging monitoring in accordance with one or more aspects of the present disclosure. In some examples, the wireless communications system 200 may implement aspects of the wireless communications system 100. For example, the wireless communications system 200 includes a UE 115-a, a UE 115-b, and a UE 115-c, which may be examples of the corresponding devices described with reference to FIG. 1. The UEs 115 may operate in one or more coverage areas 210, which may be examples of the coverage areas 110 described with reference to FIG. 1. The wireless communications system 200 also includes a first cell 205-a, a second cell 205-b, and a third cell 205-c, which may each be examples of one or more other types of wireless devices, such as a network entity 105, a CU 160, a DU 165, an AMF included in a core network 130, a gNB, or another type of wireless device. Thus, although aspects of the present disclosure are described with reference to one or more UEs 115 and one or more cells 205, it is understood that the described techniques may be performed by a wireless device different from a UE 115 and a cell 205. As described herein, operations performed by the UE 115-a, the UE 115-b, the UE 115-c, the first cell 205-a, the second cell 205-b, and the third cell 205-c may be respectively performed by a UE 115, a network entity 105, or another wireless device, and the examples shown should not be construed as limiting.

Devices in the wireless communications system 200 may support network energy savings via on-demand system information. For example, a network entity 105 (e.g., the first cell 205-a, the second cell 205-b, the third cell 205-c, or a combination thereof) may save transmission power by refraining from transmitting an always-on signal, and may only output (e.g., transmit) messages for a UE 115 in response to an on-demand system information request from the UE 115. System information may include a SIB1 (e.g., a first set of system information, or essential system information), other system information (OSI) (e.g., optional system information), remaining system information (RMSI), or a combination thereof. For example, a network entity 105 may transmit an SSB and a SIB1 message to a UE 115 to begin wireless communications with the UE 115 in the wireless communications system 200. In some examples, the UE 115 may request additional system information (e.g., OSI or RMSI, such as a SIB-7 message or a SIB-x message) by transmitting a msg1 to the network entity 105. In some examples, the UE 115 may connect to the network entity 105 via a contention-free procedure (e.g., contention-free random access (CFRA)) or via a contention-based procedure (e.g., contention-based random access (CBRA)). In some cases, to save energy, the network entity 105 may selectively output an SSB, a SIB1 message, or both (e.g., rather than continuously outputting these messages). For example, the network entity 105 may refrain from outputting (e.g., via an NES cell such as the second cell 205-b or the third cell 205-c) an SSB, a SIB1 message, or both until obtaining (e.g., receiving) a wake-up signal from the UE 115.

In some examples, the wireless communications system 200 may include a first cell 205-a, which may be referred to as an anchor cell or an umbrella cell. One or more NES cells (e.g., the second cell 205-b and the third cell 205-c) may be within a first coverage area 210-a (e.g., a tracking area (TA) or RAN-based notification area (RNA) of the first cell 205-a). One or more UEs 115 may be within a first coverage area 210-a associated with the first cell 205-a, within a second coverage area 210-b associated with the second cell 205-b, within a third coverage area 210-c associated with the third cell 205-c, or a combination thereof. For example, the UE 115-a may be within the first coverage area 210-a; the UE 115-b may be within the first coverage area 210-a and the second coverage area 210-b; and the UE 115-c may be within the first coverage area 210-a and the third coverage area 210-c. Each NES cell may be associated with a set of SSBs (e.g., a quantity of paging occasions or paging channels associated with a set of one or more SSBs). For example, a first SSB set 215-a may be associated with the first cell 205-a, a second SSB set 215-b (e.g., including a first SSB 220-a, a second SSB 220-b, and a third SSB 220-c) may be associated with the second cell 205-b, and a third SSB set 215-c may be associated with the third cell 205-c). An NES cell may opportunistically serve a UE 115 that enters a coverage area associated with the NES cell and may shut down (e.g., refrain from transmitting) when the UE 115 leaves the coverage area to minimize energy consumption and reduce interference between cells. For example, the second cell 205-b may be in an energy-saving mode at time t0 (e.g., before the UE 115-b enters the second coverage area 210-b associated with the second cell 205-b) and may wake up when the UE 115-b enters the coverage area 210 at time t1 (e.g., in response to a cell reselection criteria being met, or in response to an on-demand system information request from the UE 115-b).

In some examples, at time t0, the UE 115-b may receive assistance information from the first cell 205-a. For example, the assistance information may include information about one or more NES cells within the first coverage area 210-a, such as cell ID information, coverage area information, beam information, timing information associated with a system information request message, or a combination thereof for the second cell 205-b and for the third cell 205-c. In some cases, the assistance information may inform the UE 115-b how to wake up the second cell 205-b to obtain system information.

However, if the UE 115-b does not include a unique UE ID in the system information request message (e.g., an on-demand system information block 1 (OD-SIB1) request message), then the second cell 205-b may not know which paging channel (e.g., associated with an SSB) to use to page the UE 115-b, if any. As a result, the second cell 205-b may output paging messages for the UE 115-b via multiple paging channels (e.g., paging occasions), including one or more paging channels that the UE 115-b does not monitor for paging messages. In some examples, the second cell 205-b may continue to output paging messages for the UE 115-b after the UE 115-b has left (e.g., is no longer camped on) the second coverage area 210-b. If the UE ID associated with the UE 115-b that is requesting system information is unknown to the second cell 205-b (e.g., the OD-SIB NES cell), then the network may blindly transmit a paging message addressing the UE 115-b via the second cell 205-b without knowing whether the UE 115-b is camping on the second cell 205-b. Instead, the network may transmit the paging message based on obtaining the on-demand system information request message without knowing which UE 115 transmitted the one-demand system information request message (e.g., as far as the network knows, the on-demand system information request message may have been sent by the UE 115-a, the UE 115-b, or the UE 115-c). This may be the case when the on-demand system information request message does not identify the UE 115 that is issuing the request.

Additionally, or alternatively, if the SSB ID associated with the paging occasion in which the UE 115-b monitors for the paging message is unknown to the second cell 205-b, then the second cell 205-b may transmit the paging message to the UE 115-b over the entire SSB ID coverage (e.g., via paging occasions or paging channels associated with the first SSB 220-a, the second SSB 220-b, and the third SSB 220-c). Thus, the second cell 205-b may use the following information to reduce power consumption for paging the UE 115-b: a UE ID associated with the UE 115-b which may monitor for the paging message from the second cell 205-b, and an SSB ID associated with the paging occasion in which the UE 115-b may monitor for the paging message (e.g., the first SSB 220-a at time t1 and the second SSB 220-b at time t2).

In some implementations, the UE 115-b may report a UE ID alongside the OD-SIB1 request. When requesting an OD-SIB1, the UE 115-b may send a UE identifier (e.g., a temporary mobile subscriber identifier (TMSI) or an I-RNTA over msg3 or a PUSCH in msgA) depending on an RRC state of the UE 115-b and one or more resources used for the OD-SIB1 request. That is, the UE 115-b may transmit, upon transitioning from a first location in the first coverage area 210-a to a second location in the second coverage area 210-b associated with the second cell 205-b at time t1 (e.g., in a coverage area of the first SSB 220-a), an on-demand system information request that includes a unique identifier for the UE 115-b. Note that an OD-SIB1 may be an example or a representative use case, but the system information described in the present disclosure may not be limited to an OD-SIB1. For example, the system information may be an on-demand other system information (OD-OSI), an SSB, a RACH, or another type of system information. Similarly, the OD-SIB1 request may be a message requesting any type of system information.

When waking up the OD-SIB1 NES cell (e.g., the second cell 205-b) to request an OD-SIB1 message by transmitting a msg1 or a PRACH message in a msgA, the UE 115-b may introduce itself to the OD-SIB1 NES cell by sending a UE ID. For example, the UE ID may be a TMSI (e.g., if the UE 115-b is in an RRC Idle mode) or an inactive radio network temporary identifier (I-RNTI) (e.g., if the UE 115-b is in an RRC inactive mode) over a msg3 or a PUSCH message in a msgA. If the request signal is a msg1 and the UE 115-b receives an uplink grant in a random access response (RAR) in response to the msg1, the UE 115-b may include the UE 115-b identifier information in a msg3 scheduled by the RAR or in a PUSCH message scheduled by a TC-RNTI for retransmission. If the request signal is a PRACH message in a msgA, the UE 115-b may include the UE identifier information in a PUSCH message in the msgA.

In response, the network (e.g., the gNB, the second cell 205-b) may facilitate a dedicated uplink message based on a cell paging beam update by assigning a dedicated msg1 or msgA (e.g., a dedicated remote access point identifier (RAPID) associated with multiple adjacent transmission beams with respective SSB IDs) to the UE 115-b. For example, based on obtaining the on-demand system information request including the unique identifier for the UE 115-b, the network may output, via the second cell 205-b, a message that includes both system information and an indication of one or more resources for a location update message. The one or more resources (e.g., periodic resources, one or more preamble IDs) may be dedicated for the UE 115-b and may be associated with at least a second SSB ID of the second cell 205-b (e.g., associated with the second SSB 220-b, the third SSB 220-c, or both). For example, the network may expect that those resources will be used by the UE 115-b (e.g., and not the UE 115-a, the UE 115-c, or another UE 115) when the UE 115-b transitions from a first SSB ID coverage to a second SSB ID coverage. When the network obtains a message (e.g., a location update message or an OD-SIB1 request message) via the one or more dedicated resources via a second SSB ID of the second cell 205-b (e.g., the second SSB 220-b), the network may know that the UE 115-b has moved into the coverage of the second SSB ID and may output one or more paging messages to the UE 115-b via a paging channel associated with the second SSB ID based on obtaining the message via the one or more dedicated resources.

In response to the OD-SIB1 message request (e.g., the on-demand system information request), the second cell 205-b may assign, to the UE 115-b, the one or more resources (e.g., a dedicated PRACH resource, a dedicated RAPID associated with one or more SSB IDs other than the SSB ID associated with the OD-SIB1 message request, such as a dedicated RAPID associated with the second SSB 220-b) or a dedicated resource in a msg3. The UE 115-b may use the dedicated resource when the UE 115-b moves (e.g., transitions, relocates) and reselects another SSB ID for a paging message monitoring from the second cell 205-b. When the UE 115-b moves to another SSB ID service coverage, e.g., the new SSB ID has a better reference signal received power (RSRP) for a paging monitoring by an RSRP level than the current SSB ID, and decides to monitor a paging channel from the new SSB ID, the UE 115-b may transmit the assigned (e.g., dedicated) resource to the second cell 205-b to let the second cell 205-b know the UE 115-b monitors a paging channel associated with the corresponding SSB ID, not the previous SSB ID.

Upon a change in gNB SSB ID for paging channel monitoring, the UE 115-b may transmit the dedicated msg1 or msgA corresponding to the new SSB ID. At time t2, the UE 115-b may transition from the second location associated with the first SSB ID (e.g., the first SSB 220-a) of the second cell 205-b to a third location associated with the second SSB ID (e.g., the second SSB 220-b). Based on the transition, the UE 115-b may transmit, via the one or more dedicated resourced indicated by the second cell 205-b, a location update message. Upon the detection of the transmitted signal from the UE 115-b, the second cell 205-b may stop outputting a paging channel to the UE 115-b in paging occasions associated with the previous SSB ID (e.g., associated with the first SSB 220-a) and may use the SSB ID associated with the detected signal for paging channel transmission to the UE 115-b (e.g., associated with the second SSB 220-b). That is, the network may refrain from outputting a paging channel for the UE 115-b over the entire paging monitoring occasions associated with all SSB IDs (e.g., associated with the first SSB set 215-a, the third SSB set 215-c, the first SSB 220-a, and the third SSB 220-c at time t2, when the UE 115-b is location in a beam associated with the second SSB 220-b). Rather, the network may selectively output the paging channel based on a most recently updated or detected UE location update within the cell coverage (e.g., based on the location update message).

In some examples, whether UE 115-b performs the location update as part of system information, SSB, or RACH request can be configurable, e.g., via a SIB1 configuration in relation to on-demand OSI, or via OSI configuration for neighbor cells. That is, the network may output, via the first cell 205-a or the second cell 205-b, and the UE 115-b may receive, an indication of whether the location update message may be associated with a system information request, an SSB request, or a RACH request. The UE 115-b may transmit the location update message at time t2 based on the indication.

In some examples, the proposed scheme may be made applicable depending on UE mobility (e.g., whether the UE 115-b is stationary, pseudo-stationary, or mobile). For example, the UE 115-b may include a unique UE ID in the system information request message based on the UE 115-b being mobile. The UE 115-b mobility condition may be based on the registered UE device or service type, or the UE 115-b may autonomously determine the UE 115-b mobility condition based on a measured RSRP deviation. If the proposed scheme is appliable only for a subset of device types or service types, there may be a waiting time (e.g., a delay) after the UE 115-b transmits the system information request message and before the UE 115-b receives the system information message for network coordination.

In some examples, the application of the proposed scheme may not be limited to an NES cell (e.g., the second cell 205-b may not be an NES cell). The scheme may bring a power saving benefit to both the UE 115-b and the network. First, the network may output one or more paging messages to a specific transmission beam direction (e.g., associated with the second SSB 220-b) rather than all SSB beams (e.g., associated with the first SSB 220-a, the second SSB 220-b, and the third SSB 220-c). Second, any UEs in SSB transmission beams other than the SSB beam where the paging target UE 115-b is located may not unnecessarily receive the paging physical downlink control channel (PDCCH) (e.g., the UE 115-a and the UE 115-c may not receive the one or more paging messages for the UE 115-b). Thus, the UE 115-a and the UE 115-c may save energy by refraining from attempting to decode the scheduled paging physical downlink shared channel (PDSCH).

Additionally, or alternatively, the wireless communications system 200 may support backhaul signaling aspects when the UE 115-b discloses a UE ID in the system information request message. For example, as discussed herein, the UE 115-b may include a UE paging ID (e.g., a unique identifier for the UE 115-b) in the on-demand system information request message (e.g., for OD-SIB1, OD-OSI, SSB, or other system information). The UE ID may provide the network with a more recent location of the UE 115-b to assist the network with forming a paging route (e.g., a paging strategy). For example, a paging route may involve a paging message being output from the first cell 205-a to the second cell 205-b via a paging channel associated with an SSB of the first SSB set 215-a, and from the second cell 205-b to the UE 115-b via a paging channel associated with first SSB 220-a, based on the location of the UE 115-b at time t1. The paging route generated by the network may be a relatively efficient route to get the one or more paging messages to the UE 115-b, compared to other possible routes. However, in some cases, the recipient of the on-demand system information request message from the UE 115-b may be different from the initiator of the one or more paging messages for the UE 115-b. For example, a msg1 from the UE 115-b may terminate at a DU (e.g., a DU 165, as discussed with reference to FIG. 1, or another relatively lower layer entity), while a msg3 may terminate at a CU (e.g., a CU 160, as discussed with reference to FIG. 1, or another relatively lower layer entity). RAN-based paging may originate from the CU, while core network (CN)-based paging may originate from an AMF (e.g., an AMF included in a core network 130, as discussed with reference to FIG. 1, or another relatively higher layer entity). If the UE 115-b enhances the msg1 or the msg3 by including the UE ID, the UE ID may not be used to form a paging route since the recipient of the msg1 (the DU) or msg3 (the CU) may be different from the initiator of the paging (e.g., the CU or the AMF). Additional signaling may be desired for improved coordination between devices.

In some examples, the UE 115-b may include a TMSI in the on-demand system information request message, where the network may have one or more CN-based paging messages for the UE 115-b (e.g., similar discussion may apply to other examples, such as the UE 115-b including an I-RNTI in the on-demand system information request message and the network having one or more RAN-based paging messages for the UE 115-b).

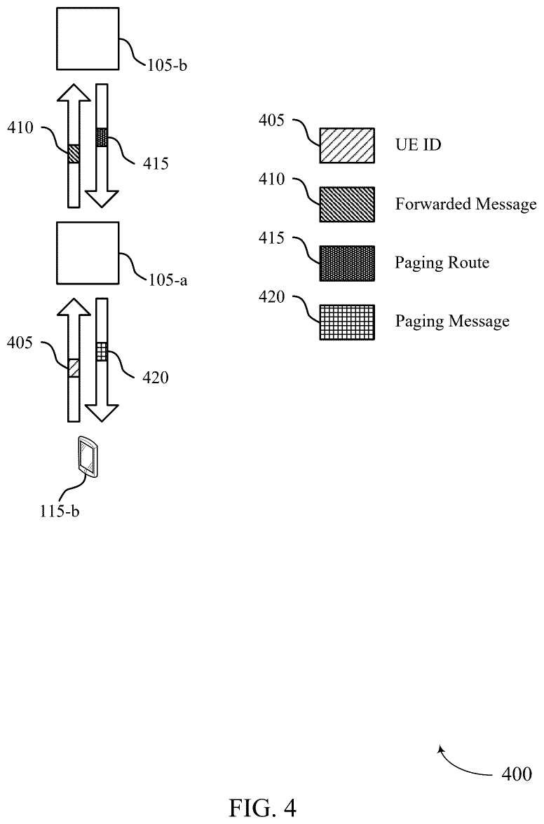

There are at least two options (e.g., behaviors) for the relatively low layer network node (e.g., a first network entity 105-a as described in more detail with reference to FIGS. 4, 5, and 6, which may be a CU, a DU, a gNB, or another device). In a first option, the first network entity may obtain the UE ID (e.g., the TMSI) as part of the location update message from the UE 115-b and may forward the UE location update message including the UE ID to a relatively higher-tier (e.g., higher layer) network node (e.g., a second network entity 105-b as described in more detail with reference to FIGS. 4, 5, and 6, which may be a CU, a gNB, an AMF, or another device. In some examples, the first network entity may include assistance information when forwarding the location update message to the second network entity, such as cell identifier information, coverage area information, beam information, timing information associated with the message that requests system information, or a combination thereof. The second network entity may use the forwarded information to generate (e.g., develop, optimize) a paging route for one or more paging messages for the UE 115-b. The second network entity may output a message instructing the first network entity to page the UE 115-b based on the paging route. The first network entity may forward or output one or more paging messages to the UE 115-b in accordance with the paging route (e.g., via the second cell 205-b, via the beam associated with the second SSB 220-b at time t2), based on obtaining the message (e.g., instructions, request, paging route) from the second network entity.

As an example of the first option, a CU (e.g., the first network entity) may check for routing information inside a TMSI (e.g., the UE ID, via a msg3) obtained from the UE 115-b and may identify a first AMF (e.g., the second network entity). The CU may send (e.g., output) the location update message to the identified AMF, including the TMSI. The CU may release the TMSI. This first option may allow the AMF to generate a paging route (e.g., optimize a paging strategy) for the UE 115-b based on the extra location update. In some examples, this first option may reuse the location update procedure between the CU and the AMF, e.g., to introduce a new event type, such as a system information demand by the UE 115-b. In some cases, the AMF (e.g., the higher layer second network entity) may configure this first option on the CU (e.g., the lower layer first network entity).

In a second option, the first network entity may obtain the on-demand system information request message from the UE 115-b, including the UE ID (e.g., the TMSI). Rather than forwarding the message to the second network entity as in the first option, the first network entity may store (e.g., cache) the UE ID, assistance information, or both based on the UE location update. The assistance information may include cell identifier information, coverage area information, beam information, timing information associated with the message that requests system information, or a combination thereof. Using the stored information, the first network entity may generate (e.g., develop, optimize) a paging route (e.g., paging strategy). The first network entity may obtain, from the second network entity, a paging request to page the UE associated with the UE ID (e.g., the UE 115-b), and may output one or more paging messages for the UE 115-b based on obtaining the paging request. In some examples, the first network entity may refrain from generating the paging route until obtaining the paging request from the second network entity.

As an example of the second option, a CU (e.g., the first network entity) may check for routing information inside the TMSI (e.g., the UE ID, via a msg3) obtained from the UE 115-b and may identify a first AMF (e.g., the second network entity), as in the first option. The CU may store (e.g., cache), the TMSI and may, e.g., refrain from notifying or forwarding information to the first AMF as in the first option. Upon obtaining a paging request from the first AMF including the cached TMSI (e.g., matching the stored UE ID), the CU may generate a paging route (e.g., optimize a paging strategy) based on a list of cells provided by the first AMF and a cell ID included in an F1 message that transported the msg3 with the TMSI. In some cases of the second option, the CU may keep track of (e.g., store, cache) an idle UE ID, which may not occur in the case of the first option.

Again, the examples illustrated with a CU and an AMF are examples that should not be construed as limiting. In other examples, similar signaling may occur between a DU and a CU, or another combination of network entities in which a first network entity acts as a lower-tier network node and a second network entity acts as a higher-tier network node. In some examples, in order for the first option and the second option to be configured on the lower-tier network node, a new location update procedure may be defined. In some cases, similar signaling may occur between peer network entities (e.g., peer gNBs, for RAN-based paging). In such cases, the source gNB that initiates the RAN-based paging request may behave as the higher-tier network node (e.g., the second network entity) and the target gNB that executes the RAN-based paging request may behave as the lower-tier network node (e.g., the first network entity).

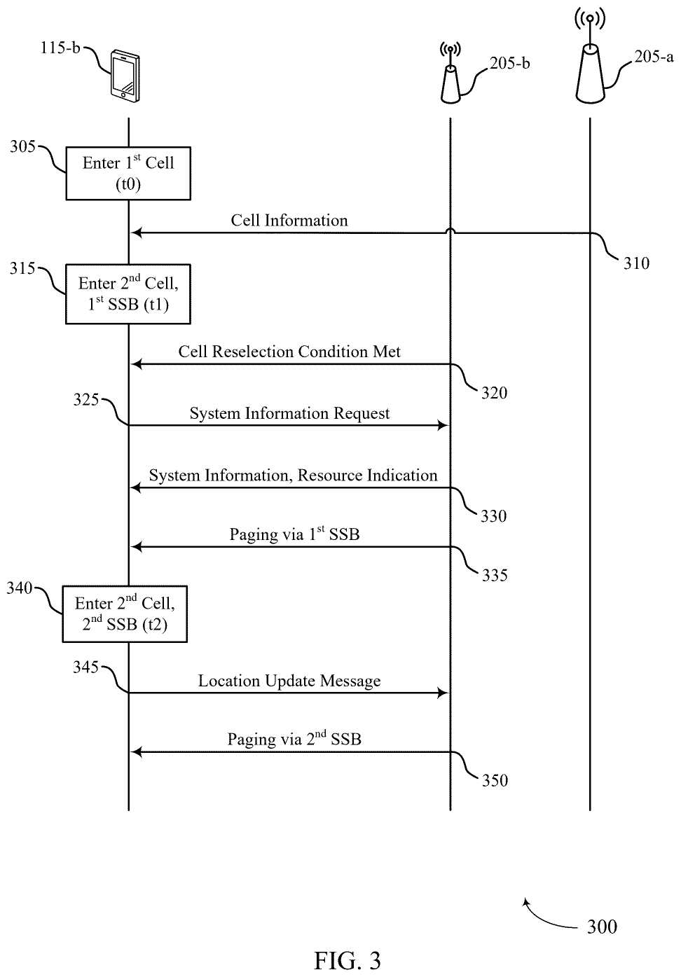

FIG. 3 shows an example of a process flow 300 that supports location updates for paging monitoring in accordance with one or more aspects of the present disclosure. In some examples, the process flow 300 may be implemented by, or may implement aspects of, the wireless communications systems 100 and 200 and the signaling diagrams 400 and 500. For example, the process flow 300 includes a first cell 205-a (e.g., an anchor cell, a CU, a DU, a gNB, an AMF), a second cell 205-b (e.g., an NES cell, a CU, a DU, gNB, an AMF), and a UE 115-b (e.g., a UE 115 operating in an idle mode), which may be examples of the corresponding devices described with reference to FIGS. 1 and 2. Following the process flow 300, the UE 115-b may perform an enhanced location update procedure with the first cell 205-a (e.g., an anchor cell) and the second cell 205-b (e.g., an NES cell, which may be one of a set of one or more cells configured with an NES mode in the coverage area of the first cell 205-a). Alternative examples of the following may be implemented, where some steps are performed in a different order than described or are not performed at all. In some cases, steps may include additional features not mentioned below, or further steps may be added. Although the UE 115-b, the first cell 205-a, and the second cell 205-b are shown performing the operations of the process flow 300, some aspects of some operations may also be performed by one or more other wireless devices.

At 305 (e.g., at time t0), the UE 115-b may enter (e.g., be located in, transition to) the coverage area of the first cell 205-a (e.g., the first coverage area 210-a as described with reference to FIG. 2). The UE 115-b may be in an area (e.g., a first location) associated with an SSB of the first cell 205-a (e.g., an SSB of the first SSB set 215-a described with reference to FIG. 2).

At 310, the first cell 205-a may output or transmit a message including information about one or more other cells (e.g., including the second cell 205-b) in the coverage area of the first cell 205-a, where the one or more other cells may be configured with a network energy savings mode. The UE 115-b may receive the message including cell information via the first cell 205-a and while operating in an idle mode.

At 315 (e.g., at time t1), the UE 115-b may enter (e.g., transition to) a second cell (e.g., the second cell 205-b) in the coverage area of the first cell 205-a. That is, the UE 115-b may transition from a first location that is in the coverage area of the first cell 205-a and that is outside the coverage area of the second cell 205-b to a second location that is in the coverage area of the first cell 205-a and that is in the coverage area of the second cell 205-b. More specifically, the second location may be associated with a first SSB ID of the second cell 205-b (e.g., associated with the first SSB 220-a described with reference to FIG. 2).

At 320, a cell reselection condition may be met, e.g., based on the UE 115-b transitioning from the first location to the second location at 315. For example, the UE 115-b may be aware that it has transitioned from the first location that is in the coverage area of the first cell 205-a and that is outside the coverage area of the second cell 205-b to the second location that is in the coverage area of the first cell 205-a and that is in the coverage area of the second cell 205-b.

At 325, the UE 115-b may transmit, via the second cell 205-b and based on transitioning to the second cell 205-b in the coverage area of the first cell 205-a at 320, an on-demand system information request (e.g., an OD-SIB1 request) including a unique identifier for the UE 115-b. The unique identifier for the UE 115-b may be a TMSI or an I-RNTI based on an RRC mode of the UE 115-b. In some examples, the on-demand system information request may include an OD-SIB1, an OD-OSI, an SSB, or a RACH.

At 330, the second cell 205-b may output, and the UE 115-b may receive based on the on-demand system information request transmitted at 325, a message including system information (e.g., OD-SIB1 acquisition). In some examples, the message may include an indication of one or more resources for a location update message (e.g., the location update message transmitted at 345). The one or more resources may be dedicated for the UE 115-b and may be associated with at least a second SSB ID of the second cell 205-b (e.g., the second SSB 220-b described with reference to FIG. 2). In some examples, the one or more resources may be associated with a dedicated RAPID. In some examples, the one or more resources may include two or more adjacent transmission beams. Each adjacent transmission beam may be associated with a respective SSB ID. For example, a first adjacent transmission beam may be associated with the first SSB ID of the second cell 205-b and a second adjacent transmission beam may be associated with the second SSB ID of the second cell 205-b. In some examples, the UE 115-b may receive an indication of whether the location update message to be transmitted at 345 is associated with a system information request, an SSB request, or a RACH request.

At 335, the second cell 205-b may output, via a first paging channel associated with a first SSB ID of the second cell 205-b (e.g., the first SSB 220-a described with reference to FIG. 2), one or more paging messages based on the on-demand system information request obtained (e.g., received) at 325. The UE 115-b may monitor for and receive the one or more paging messages via the second cell 205-b based on transmitting the on-demand system information request at 325.

At 340 (e.g., at time t2), the UE 115-b may enter (e.g., transition to) a third location in the coverage area of the first cell 205-a and the second cell 205-b that is associated with the second SSB ID of the second cell 205-b (e.g., the second SSB 220-b described with reference to FIG. 2).

At 345, the UE 115-b may transmit, to the second cell 205-b and via the one or more resources indicated at 330, the location update message based on transitioning from the second location associated with the first SSB ID of the second cell 205-b to the third location associated with the second SSB ID of the second cell 205-b at 340. In some examples, the UE 115-b may transmit the location update message based on the indication received at 330 indicating whether the location update message is associated with a system information request, an SSB request, or a RACH request. In some examples, the second cell 205-b may refrain from outputting one or more paging messages via the first paging channel associated with the first SSB ID based on the location update message (e.g., based on the location update message indicating that the UE 115-b has moved or transitioned to a third location that is not associated with the first SSB ID).

At 350, the second cell 205-b may output, based on the location update message obtained at 345 and via a second paging channel associated with the second SSB ID, one or more paging messages for the UE 115-b. The UE 115-b may monitor the second paging channel and receive the one or more paging messages based on transmitting the location update message at 345.

FIG. 4 shows an example of a signaling diagram 400 that supports location updates for paging monitoring in accordance with one or more aspects of the present disclosure. The signaling diagram 400 may implement or be implemented by one or more aspects of the wireless communications system 100, the wireless communications system 200, and the process flow 300 described with reference to FIGS. 1, 2, and 3, respectively. For example, the signaling diagram 400 may be implemented by a first network entity 105-a (e.g., a CU, a DU, a gNB, an AMF), a second network entity 105-b (e.g., a CU, a DU, gNB, an AMF), and a UE 115-b (e.g., a UE in an idle mode) as described with reference to FIGS. 1 and 2 to support an enhanced location update procedure.

As described with reference to FIG. 2, the signaling diagram 400 may support backhaul signaling aspects when the UE 115-b discloses a UE ID 405 in an on-demand system information request message. For example, the UE 115-b may include the UE ID 405 (e.g., a unique identifier for the UE 115-b, a UE paging ID) in the on-demand system information request message transmitted to the first network entity 105-a, which may request an OD-SIB1, OD-OSI, SSB, or other system information. The UE ID 405 may provide the network with a recent location of the UE 115-b to assist the network with forming a paging route 415 (e.g., a paging strategy). However, in some cases, the recipient of the on-demand system information request message from the UE 115-b may be different from an initiator of one or more paging messages 420 for the UE 115-b. For example, a msg1 from the UE 115-b may terminate at a DU (e.g., a DU 165, as discussed with reference to FIG. 1, or another relatively lower layer entity), while a msg3 may terminate at a CU (e.g., a CU 160, as discussed with reference to FIG. 1, or another relatively lower layer entity). RAN-based paging may originate from the CU, while CN-based paging may originate from an AMF (e.g., an AMF included in a core network 130, as discussed with reference to FIG. 1, or another relatively higher layer entity). If the UE 115-b enhances the msg1 or the msg3 by including the UE ID 405, the UE ID 405 may not be used to form a paging route 415 since the recipient of the msg1 (the DU) or msg3 (the CU) may be different from the initiator of the one or more paging messages 420 (e.g., the CU or the AMF). Additional signaling may be desired for improved coordination between devices.

In some examples, the UE 115-b may include a TMSI in the on-demand system information request message, where the network may have one or more CN-based paging messages 420 for the UE 115-b (e.g., similar discussion may apply to other examples, such as the UE 115-b including an I-RNTI in the on-demand system information request message and the network having one or more RAN-based paging messages 420 for the UE 115-b).

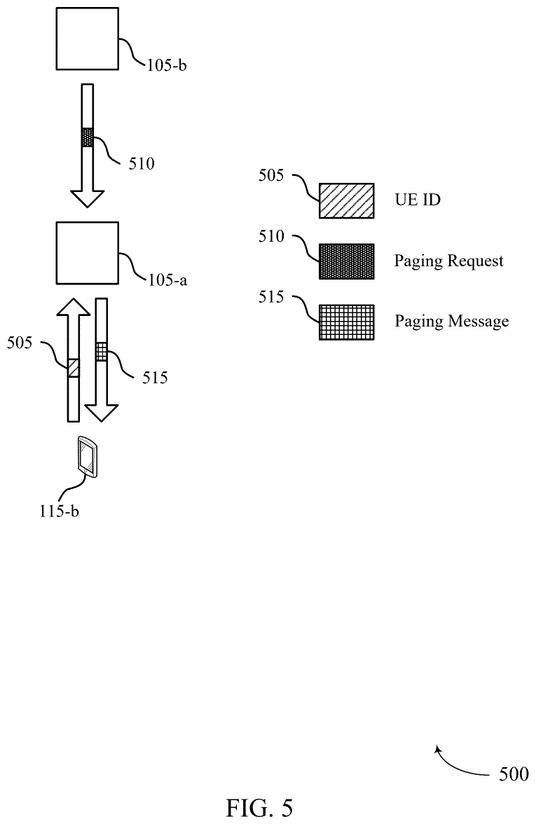

There are at least two options (e.g., behaviors) for the relatively low layer network node (e.g., the first network entity 105-a, which may be a CU, a DU, a gNB, or another device). The first option is illustrated by FIG. 4 and the second option is illustrated by FIG. 5. In the first option, the first network entity 105-a may obtain (e.g., receive) the UE ID 405 (e.g., the TMSI) as part of the location update message from the UE 115-b and may forward the UE location update message (e.g., output or transmit a forwarded message 410) including the UE ID 405 to a relatively higher-tier (e.g., higher layer) network node (e.g., the second network entity 105-b, which may be a CU, a gNB, an AMF, or another device. In some examples, the first network entity 105-a may include assistance information in the forwarded message 410 for the second network entity 105-b, such as cell identifier information, coverage area information, beam information, timing information associated with the message that requests system information, or a combination thereof. The second network entity 105-b may use the forwarded message 410 to generate (e.g., develop, optimize) a paging route 415 for one or more paging messages 420 for the UE 115-b. For example, the paging route 415 may involve one or more cells (e.g., the second cell 205-b described with reference to FIG. 2) and one or more paging channels associated with one or more SSB IDs (e.g., associated with the first SSB 220-a described with reference to FIG. 2) that the first network entity 105-a may use to output one or more paging messages 420 to the UE 115-b. The second network entity 105-b may output a message instructing the first network entity 105-a to page the UE 115-b based on the paging route 415 generated at the second network entity 105-b. The first network entity 105-a may forward or output one or more paging messages 420 to the UE 115-b in accordance with the paging route 415 (e.g., via the second cell 205-b, via the beam associated with the second SSB 220-b at time t2 described with reference to FIG. 2), based on obtaining the message (e.g., instructions, request, paging route 415) from the second network entity 105-b.

As an example of the first option, a CU (e.g., the first network entity 105-a) may check for routing information inside a TMSI (e.g., the UE ID 405, via a msg3) obtained from the UE 115-b and may identify a first AMF (e.g., the second network entity 105-b). The CU may send (e.g., output) the location update message to the identified AMF, including the TMSI. The CU may release the TMSI. This first option may allow the AMF to generate a paging route 415 (e.g., optimize a paging strategy) for the UE 115-b based on the extra location update. In some examples, this first option may reuse the location update procedure between the CU and the AMF, e.g., to introduce a new event type, such as a system information demand by the UE 115-b. In some cases, the AMF (e.g., the higher layer second network entity 105-b) may configure this first option on the CU (e.g., the lower layer first network entity 105-a).

Again, the examples illustrated with a CU and an AMF are examples that should not be construed as limiting. In other examples, similar signaling may occur between a DU and a CU, or another combination of network entities 105 in which a first network entity 105-a acts as a lower-tier network node and a second network entity 105-b acts as a higher-tier network node. In some examples, in order for the first option and the second option to be configured on the lower-tier network node (e.g., the first network entity 105-a), a new location update procedure may be defined. In some cases, similar signaling may occur between peer network entities 105 (e.g., peer gNBs, for RAN-based paging). In such cases, the source gNB that initiates the RAN-based paging request may behave as the higher-tier network node (e.g., the second network entity 105-b) and the target gNB that executes the RAN-based paging request may behave as the lower-tier network node (e.g., the first network entity 105-a).

FIG. 5 shows an example of a signaling diagram 500 that supports location updates for paging monitoring in accordance with one or more aspects of the present disclosure. The signaling diagram 500 may implement or be implemented by one or more aspects of the wireless communications system 100, the wireless communications system 200, and the process flow 300 described with reference to FIGS. 1, 2, and 3, respectively. For example, the signaling diagram 500 may be implemented by a first network entity 105-a (e.g., a CU, a DU, a gNB, an AMF), a second network entity 105-b (e.g., a CU, a DU, gNB, an AMF), and a UE 115-b (e.g., a UE in an idle mode) as described with reference to FIGS. 1 and 2 to support an enhanced location update procedure.

As described with reference to FIG. 2, the signaling diagram 500 may support backhaul signaling aspects when the UE 115-b discloses a UE ID 505 in an on-demand system information request message. For example, the UE 115-b may include the UE ID 505 (e.g., a unique identifier for the UE 115-b, a UE paging ID) in the on-demand system information request message transmitted to the first network entity 105-a, which may request an OD-SIB1, OD-OSI, SSB, or other system information. The UE ID 505 may provide the network with a recent location of the UE 115-b to assist the network with forming a paging route (e.g., a paging strategy). However, in some cases, the recipient of the on-demand system information request message from the UE 115-b may be different from an initiator of one or more paging messages 515 for the UE 115-b. For example, a msg1 from the UE 115-b may terminate at a DU (e.g., a DU 165, as discussed with reference to FIG. 1, or another relatively lower layer entity), while a msg3 may terminate at a CU (e.g., a CU 160, as discussed with reference to FIG. 1, or another relatively lower layer entity). RAN-based paging may originate from the CU, while CN-based paging may originate from an AMF (e.g., an AMF included in a core network 130, as discussed with reference to FIG. 1, or another relatively higher layer entity). If the UE 115-b enhances the msg1 or the msg3 by including the UE ID 505, the UE ID 505 may not be used to form a paging route since the recipient of the msg1 (the DU) or msg3 (the CU) may be different from the initiator of the one or more paging messages 515 (e.g., the CU or the AMF). Additional signaling may be desired for improved coordination between devices.

In some examples, the UE 115-b may include a TMSI in the on-demand system information request message, where the network may have one or more CN-based paging messages 515 for the UE 115-b (e.g., similar discussion may apply to other examples, such as the UE 115-b including an I-RNTI in the on-demand system information request message and the network having one or more RAN-based paging messages 515 for the UE 115-b).

There are at least two options (e.g., behaviors) for the relatively low layer network node (e.g., the first network entity 105-a, which may be a CU, a DU, a gNB, or another device). The first option is illustrated by FIG. 4 and the second option is illustrated by FIG. 5. In the second option, the first network entity 105-a may obtain (e.g., receive) the on-demand system information request message from the UE 115-b, including the UE ID 505 (e.g., the TMSI). Rather than forwarding the message to the second network entity 105-b as in the first option described with reference to FIG. 4, the first network entity 105-a may store (e.g., cache) the UE ID 505, assistance information, or both based on the UE location update. The assistance information may include cell identifier information, coverage area information, beam information, timing information associated with the message that requests system information, or a combination thereof. Using the stored information, the first network entity 105-a may generate (e.g., develop, optimize) a paging route (e.g., paging strategy). For example, the paging route may involve one or more cells (e.g., the second cell 205-b described with reference to FIG. 2) and one or more paging channels associated with one or more SSB IDs (e.g., associated with the first SSB 220-a described with reference to FIG. 2) that the first network entity 105-a may use to output (e.g., transmit) one or more paging messages 515 to the UE 115-b. The first network entity 105-a may obtain, from the second network entity 105-b, a paging request 510 to page the UE associated with the UE ID 505 (e.g., the UE 115-b), and may output one or more paging messages 515 for the UE 115-b based on obtaining the paging request. In some examples, the first network entity 105-a may refrain from generating the paging route until obtaining the paging request 510 from the second network entity 105-b.

As an example of the second option, a CU (e.g., the first network entity 105-a) may check for routing information inside the TMSI (e.g., the UE ID 505, via a msg3) obtained from the UE 115-b and may identify a first AMF (e.g., the second network entity 105-b), as in the first option described with reference to FIG. 4. The CU may store (e.g., cache), the TMSI and may, e.g., refrain from notifying or forwarding information to the first AMF as in the first option. Upon obtaining a paging request 510 from the first AMF including the cached TMSI (e.g., matching the stored UE ID), the CU may generate a paging route (e.g., optimize a paging strategy) based on a list of cells provided by the first AMF and a cell ID included in an F1 message that transported the msg3 with the TMSI. In some cases of the second option, the CU may keep track of (e.g., store, cache) an idle UE ID 505, which may not occur in the case of the first option.

Again, the examples illustrated with a CU and an AMF are examples that should not be construed as limiting. In other examples, similar signaling may occur between a DU and a CU, or another combination of network entities 105 in which a first network entity 105-a acts as a lower-tier network node and a second network entity 105-b acts as a higher-tier network node. In some examples, in order for the first option and the second option to be configured on the lower-tier network node (e.g., the first network entity 105-a), a new location update procedure may be defined. In some cases, similar signaling may occur between peer network entities 105 (e.g., peer gNBs, for RAN-based paging). In such cases, the source gNB that initiates the RAN-based paging request may behave as the higher-tier network node (e.g., the second network entity 105-b) and the target gNB that executes the RAN-based paging request may behave as the lower-tier network node (e.g., the first network entity 105-a).

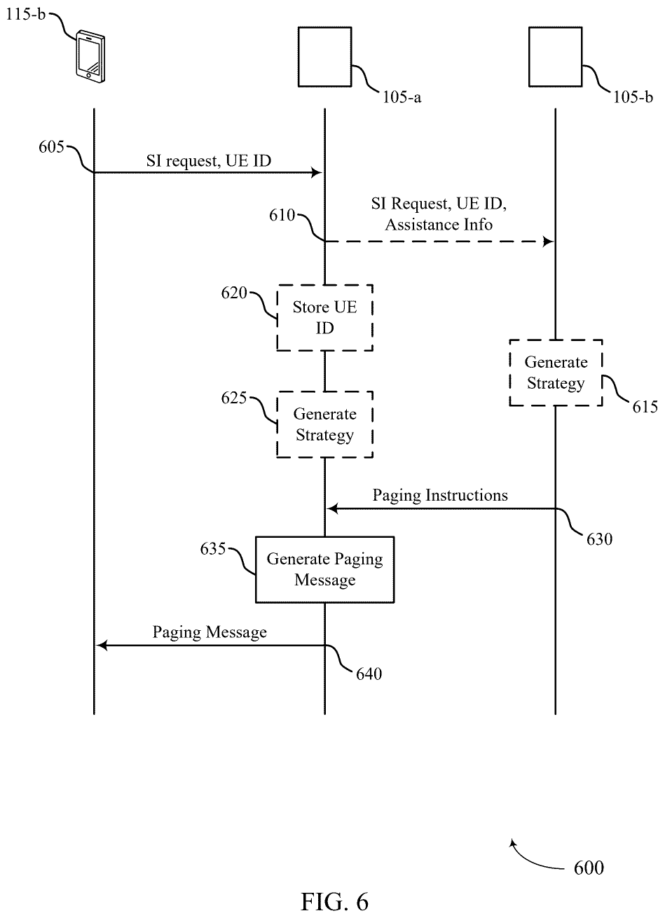

FIG. 6 shows an example of a process flow 600 that supports location updates for paging monitoring in accordance with one or more aspects of the present disclosure. In some examples, the process flow 600 may be implemented by, or may implement aspects of, the wireless communications systems 100 and 200 and the signaling diagrams 400 and 500. For example, the process flow 600 includes a first network entity 105-a (e.g., a CU, a DU, a gNB, an AMF, a relatively lower-layer network node), a second network entity 105-b (e.g., a CU, a DU, gNB, an AMF, a relatively higher-layer network node), and a UE 115-b (e.g., a UE 115 operating in an idle mode), which may be examples of the corresponding devices described with reference to FIGS. 1, 2, 4, and 5. Following the process flow 600, the UE 115-b may perform an enhanced location update procedure with the first network entity 105-a and the second network entity 105-b. Alternative examples of the following may be implemented, where some steps are performed in a different order than described or are not performed at all. In some cases, steps may include additional features not mentioned below, or further steps may be added. Although the UE 115-b, the first network entity 105-a, and the second network entity 105-b are shown performing the operations of the process flow 600, some aspects of some operations may also be performed by one or more other wireless devices.

At 605, the UE 115-b may output (e.g., transmit), and the network entity 105-a may obtain (e.g., receive), a message that requests system information and identifies the UE 115-b via a UE ID (e.g., the unique identifier for the UE 115-b described with reference to FIG. 3.

At 610, as part of a first option (e.g., an option for the behavior of the devices in the process flow 600), the network entity 105-a may forward the message (e.g., including the system information request and the UE ID), assistance information, or both to the network entity 105-b (e.g., a higher-layer network entity). As part of a second option, the network entity 105-a may refrain from outputting the message, the assistance information, or both to the network entity 105-b. The assistance information may include cell ID information, coverage area information, beam information, timing information associated with the message that requests system information at 605, or a combination thereof. The assistance information may assist the network entity 105-b in generating the paging route at 615.

At 615, as part of the first option, the network entity 105-b may generate a first paging route (e.g., a first strategy) for the network entity 105-a to page the UE 115-b at 640. Generating the first paging route may include selecting a first SSB ID associated with a first cell of a set of multiple cells (e.g., including the first cell 205-a, the second cell 205-b, and the third cell 205-c, as described with reference to FIGS. 1, 2, and 3), where the network entity 105-a may output one or more paging messages to the UE 115-b at 640 via a paging channel associated with the first SSB ID. The first paging route may efficiently communicate the one or more paging messages to the UE 115-b (e.g., may be an optimized strategy).

At 620, as part of the second option, the network entity 105-a may store (e.g., cache) the UE ID identifying the UE 115-b, assistance information, or both. As part of the first option, the network entity 105-a may refrain from storing the UE ID. The assistance information may include cell ID information, coverage area information, beam information, timing information associated with the message that requests system information at 605, or a combination thereof. The assistance information may assist the network entity 105-a in generating the paging route at 615.

At 625, as part of the second option, the network entity 105-a may generate a second paging route for the network entity 105-a to page the UE 115-b at 640. Generating the second paging route may include selecting a second SSB ID associated with a second cell of a set of multiple cells, where the network entity 105-a may output one or more paging messages to the UE 115-b at 640 via a paging channel associated with the second SSB ID. In some examples, the second paging route may be based on a list of cells provided to the network entity 105-a by the network entity 105-b, a cell ID, or both. The second paging route may efficiently communicate the one or more paging messages to the UE 115-b (e.g., may be an optimized strategy).

At 630, the network entity 105-b may output, and the network entity 105-a may obtain, instructions to page the UE 115-b via the first cell of the set of multiple cells. In the case of the first option, the network entity 105-a may obtain the instructions in accordance with the first paging route based on forwarding the message at 610. In the case of the second option, the network entity 105-a may obtain the instructions based on the stored UE ID identifying the UE 115-b that the network entity 105-a stored at 620. Additionally, or alternatively, the network entity 105-a may obtain, from the network entity 105-b, an indication of a set of multiple cells in a coverage area.

At 635, the network entity 105-a may generate a paging message for the UE 115-b based on a trigger condition. In some examples, the trigger condition may be obtaining the paging request (e.g., paging instructions) from the second network entity 105-b at 630, which may include a paging route (e.g., in option 1).

At 640, the network entity 105-a may output, to the UE 115-b while the UE 115-b is in an idle mode, the paging message generated at 635. The network entity 105-b may output the paging message via a paging channel associated with an SSB ID associated with a cell of a set of multiple cells. In the case of the first option, the network entity 105-a may output the paging message based on obtaining the instructions (e.g., the paging request) at 630. Additionally, or alternatively, the network entity 105-a may output the paging message via a first paging channel associated with the first SSB ID associated with the first cell of the set of multiple cells based on the first paging route generated by the network entity 105-b at 615 as part of the first option. In the case of the second option, the network entity 105-a may output the paging message based on obtaining the instructions (e.g., the paging request) at 630 and based on the stored UE ID identifying the UE 115-b. Additionally, or alternatively, the network entity 105-a may output the paging message based on the indication of the set of multiple cells in the coverage area obtained at 630 and based on a cell ID associated with the UE ID. Additionally, or alternatively, the network entity 105-a may output the paging message via a second paging channel associated with the second SSB ID associated with the second cell of the set of multiple cells based on the second paging route generated by the network entity 105-a at 625 as part of the second option.

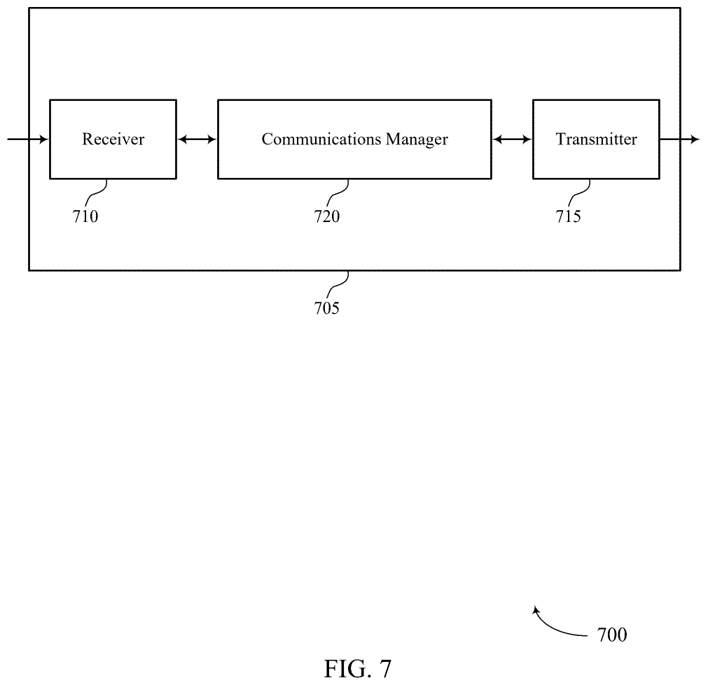

FIG. 7 shows a block diagram 700 of a device 705 that supports location updates for paging monitoring in accordance with one or more aspects of the present disclosure. The device 705 may be an example of aspects of a UE 115 as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to, individually or collectively, support or enable the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to location updates for paging monitoring). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to location updates for paging monitoring). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations or components thereof may be examples of means for performing various aspects of location updates for paging monitoring as described herein. For example, the communications manager 720, the receiver 710, the transmitter 715, or various combinations or components thereof may be capable of performing one or more of the functions described herein.

In some examples, the communications manager 720, the receiver 710, the transmitter 715, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 720, the receiver 710, the transmitter 715, or various combinations or components thereof may be implemented in code (e.g., as communications management software or firmware) executed by at least one processor (e.g., referred to as a processor-executable code). If implemented in code executed by at least one processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. For example, the communications manager 720 is capable of, configured to, or operable to support a means for receiving, via a first cell and while operating in an idle mode, a message including information about one or more other cells in a coverage area of the first cell, where one or more other cells in the coverage area are configured with a network energy savings mode. The communications manager 720 is capable of, configured to, or operable to support a means for transmitting, upon transitioning to a second cell in the coverage area of the first cell, an on-demand system information request including a unique identifier for the UE. The communications manager 720 is capable of, configured to, or operable to support a means for receiving, via the second cell, a message including system information. The communications manager 720 is capable of, configured to, or operable to support a means for monitoring, based on the on-demand system information request, a paging channel associated with a first SSB identifier of the second cell for one or more paging messages.

By including or configuring the communications manager 720 in accordance with examples as described herein, the device 705 (e.g., at least one processor controlling or otherwise coupled with the receiver 710, the transmitter 715, the communications manager 720, or a combination thereof) may support techniques for reduced processing, reduced power consumption, and more efficient utilization of communication resources.

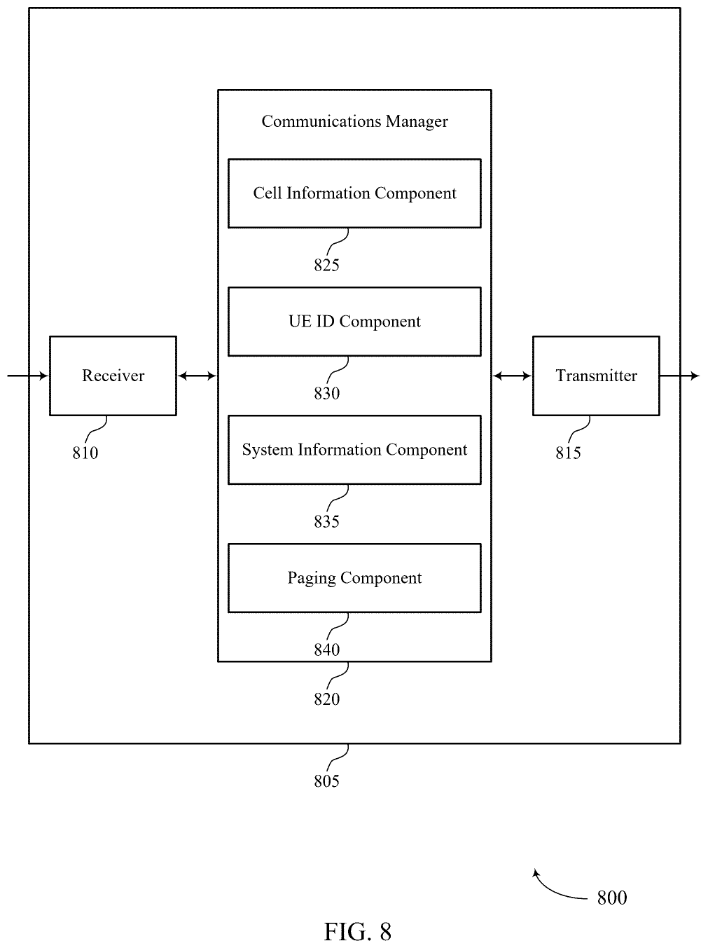

FIG. 8 shows a block diagram 800 of a device 805 that supports location updates for paging monitoring in accordance with one or more aspects of the present disclosure. The device 805 may be an example of aspects of a device 705 or a UE 115 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to support the described techniques. Each of these components may be in communication with one another (e.g., via one or more buses).

The receiver 810 may provide a means for receiving information such as packets, user data, control information, or any combination thereof associated with various information channels (e.g., control channels, data channels, information channels related to location updates for paging monitoring). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to location updates for paging monitoring). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of location updates for paging monitoring as described herein. For example, the communications manager 820 may include a cell information component 825, a UE ID component 830, a system information component 835, a paging component 840, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. The cell information component 825 is capable of, configured to, or operable to support a means for receiving, via a first cell and while operating in an idle mode, a message including information about one or more other cells in a coverage area of the first cell, where one or more other cells in the coverage area are configured with a network energy savings mode. The UE ID component 830 is capable of, configured to, or operable to support a means for transmitting, upon transitioning to a second cell in the coverage area of the first cell, an on-demand system information request including a unique identifier for the UE. The system information component 835 is capable of, configured to, or operable to support a means for receiving, via the second cell, a message including system information. The paging component 840 is capable of, configured to, or operable to support a means for monitoring, based on the on-demand system information request, a paging channel associated with a first SSB identifier of the second cell for one or more paging messages.

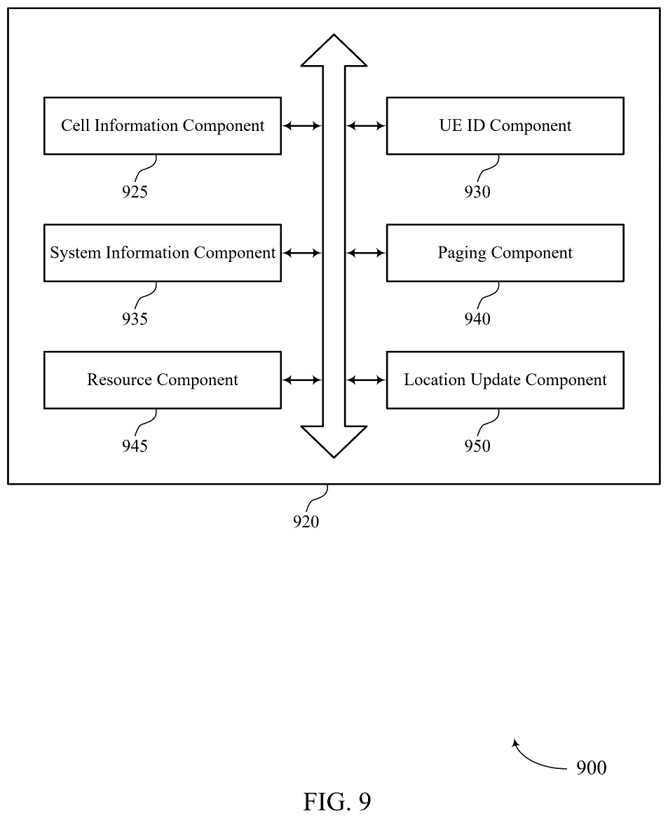

FIG. 9 shows a block diagram 900 of a communications manager 920 that supports location updates for paging monitoring in accordance with one or more aspects of the present disclosure. The communications manager 920 may be an example of aspects of a communications manager 720, a communications manager 820, or both, as described herein. The communications manager 920, or various components thereof, may be an example of means for performing various aspects of location updates for paging monitoring as described herein. For example, the communications manager 920 may include a cell information component 925, a UE ID component 930, a system information component 935, a paging component 940, a resource component 945, a location update component 950, or any combination thereof. Each of these components, or components or subcomponents thereof (e.g., one or more processors, one or more memories), may communicate, directly or indirectly, with one another (e.g., via one or more buses).

The communications manager 920 may support wireless communications in accordance with examples as disclosed herein. The cell information component 925 is capable of, configured to, or operable to support a means for receiving, via a first cell and while operating in an idle mode, a message including information about one or more other cells in a coverage area of the first cell, where one or more other cells in the coverage area are configured with a network energy savings mode. The UE ID component 930 is capable of, configured to, or operable to support a means for transmitting, upon transitioning to a second cell in the coverage area of the first cell, an on-demand system information request including a unique identifier for the UE. The system information component 935 is capable of, configured to, or operable to support a means for receiving, via the second cell, a message including system information. The paging component 940 is capable of, configured to, or operable to support a means for monitoring, based on the on-demand system information request, a paging channel associated with a first SSB identifier of the second cell for one or more paging messages.

In some examples, the resource component 945 is capable of, configured to, or operable to support a means for receiving an indication of one or more resources for a location update message, the one or more resources dedicated for the UE and associated with at least a second SSB identifier of the second cell. In some examples, the location update component 950 is capable of, configured to, or operable to support a means for transmitting, via the one or more resources, the location update message based on transitioning from a first location associated with the first SSB identifier of the second cell to a second location associated with the second SSB identifier of the second cell. In some examples, the paging component 940 is capable of, configured to, or operable to support a means for monitoring, based on the location update message, a paging channel associated with the second SSB identifier for one or more paging messages.

In some examples, the one or more resources are associated with a dedicated RAPID.

In some examples, the one or more resources include two or more adjacent transmission beams, each adjacent transmission beam associated with a respective SSB identifier.

In some examples, the location update component 950 is capable of, configured to, or operable to support a means for receiving an indication of whether the location update message is associated with a system information request, an SSB request, or a random access channel request, where transmitting the location update message is based on the indication.

In some examples, the unique identifier for the UE is a TMSI or an I-RNTI based on an RRC mode of the UE.

In some examples, the on-demand system information request includes an OD-SIB1, an OD-OSI, an SSB, or a RACH.

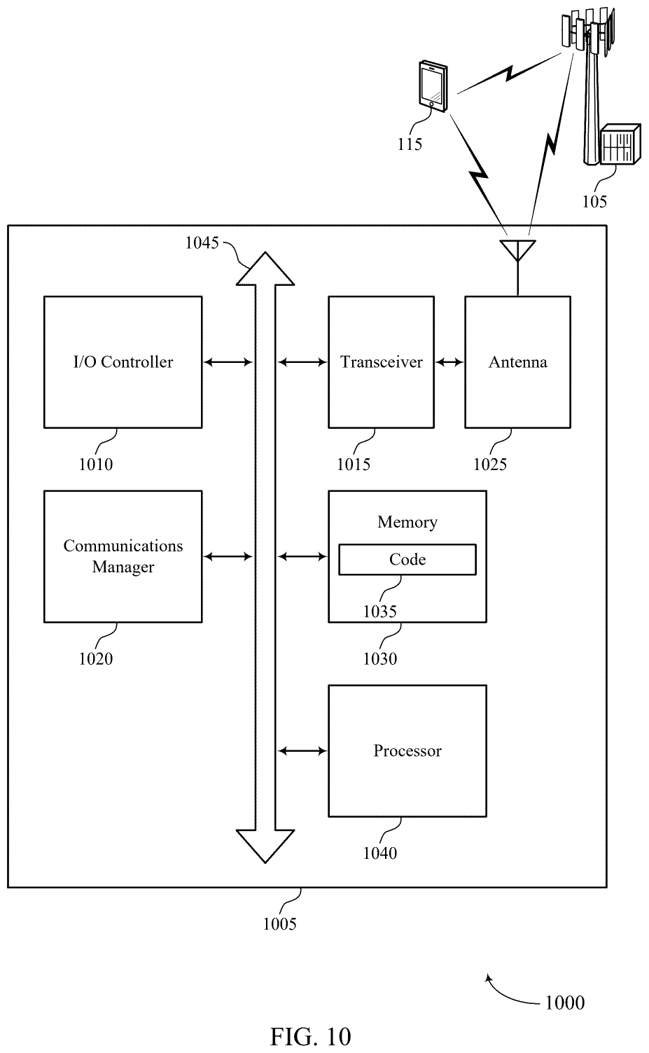

FIG. 10 shows a diagram of a system 1000 including a device 1005 that supports location updates for paging monitoring in accordance with one or more aspects of the present disclosure. The device 1005 may be an example of or include components of a device 705, a device 805, or a UE 115 as described herein. The device 1005 may communicate (e.g., wirelessly) with one or more other devices (e.g., network entities 105, UEs 115, or a combination thereof). The device 1005 may include components for bi-directional voice and data communications including components for transmitting and receiving communications, such as a communications manager 1020, an input/output (I/O) controller, such as an I/O controller 1010, a transceiver 1015, one or more antennas 1025, at least one memory 1030, code 1035, and at least one processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally, or alternatively, the I/O controller 1010 may represent or interact with a modem, a keyboard, a mouse, a touchscreen, or a similar device. In some cases, the I/O controller 1010 may be implemented as part of one or more processors, such as the at least one processor 1040. In some cases, a user may interact with the device 1005 via the I/O controller 1010 or via hardware components controlled by the I/O controller 1010.

In some cases, the device 1005 may include a single antenna. However, in some other cases, the device 1005 may have more than one antenna, which may be capable of concurrently transmitting or receiving multiple wireless transmissions. The transceiver 1015 may communicate bi-directionally via the one or more antennas 1025 using wired or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The at least one memory 1030 may include random access memory (RAM) and read-only memory (ROM). The at least one memory 1030 may store computer-readable, computer-executable, or processor-executable code, such as the code 1035. The code 1035 may include instructions that, when executed by the at least one processor 1040, cause the device 1005 to perform various functions described herein. The code 1035 may be stored in a non-transitory computer-readable medium such as system memory or another type of memory. In some cases, the code 1035 may not be directly executable by the at least one processor 1040 but may cause a computer (e.g., when compiled and executed) to perform functions described herein. In some cases, the at least one memory 1030 may include, among other things, a basic I/O system (BIOS) which may control basic hardware or software operation such as the interaction with peripheral components or devices.

The at least one processor 1040 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1040 may be configured to operate a memory array using a memory controller. In some other cases, a memory controller may be integrated into the at least one processor 1040. The at least one processor 1040 may be configured to execute computer-readable instructions stored in a memory (e.g., the at least one memory 1030) to cause the device 1005 to perform various functions (e.g., functions or tasks supporting location updates for paging monitoring). For example, the device 1005 or a component of the device 1005 may include at least one processor 1040 and at least one memory 1030 coupled with or to the at least one processor 1040, the at least one processor 1040 and the at least one memory 1030 configured to perform various functions described herein.

In some examples, the at least one processor 1040 may include multiple processors and the at least one memory 1030 may include multiple memories. One or more of the multiple processors may be coupled with one or more of the multiple memories, which may, individually or collectively, be configured to perform various functions described herein. In some examples, the at least one processor 1040 may be a component of a processing system, which may refer to a system (such as a series) of machines, circuitry (including, for example, one or both of processor circuitry (which may include the at least one processor 1040) and memory circuitry (which may include the at least one memory 1030)), or components, that receives or obtains inputs and processes the inputs to produce, generate, or obtain a set of outputs. The processing system may be configured to perform one or more of the functions described herein. For example, the at least one processor 1040 or a processing system including the at least one processor 1040 may be configured to, configurable to, or operable to cause the device 1005 to perform one or more of the functions described herein. Further, as described herein, being “configured to,” being “configurable to,” and being “operable to” may be used interchangeably and may be associated with a capability, when executing code 1035 (e.g., processor-executable code) stored in the at least one memory 1030 or otherwise, to perform one or more of the functions described herein.

The communications manager 1020 may support wireless communications in accordance with examples as disclosed herein. For example, the communications manager 1020 is capable of, configured to, or operable to support a means for receiving, via a first cell and while operating in an idle mode, a message including information about one or more other cells in a coverage area of the first cell, where one or more other cells in the coverage area are configured with a network energy savings mode. The communications manager 1020 is capable of, configured to, or operable to support a means for transmitting, upon transitioning to a second cell in the coverage area of the first cell, an on-demand system information request including a unique identifier for the UE. The communications manager 1020 is capable of, configured to, or operable to support a means for receiving, via the second cell, a message including system information. The communications manager 1020 is capable of, configured to, or operable to support a means for monitoring, based on the on-demand system information request, a paging channel associated with a first SSB identifier of the second cell for one or more paging messages.

By including or configuring the communications manager 1020 in accordance with examples as described herein, the device 1005 may support techniques for reduced latency, improved user experience related to reduced processing, reduced power consumption, more efficient utilization of communication resources, improved coordination between devices, and longer battery life.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the at least one processor 1040, the at least one memory 1030, the code 1035, or any combination thereof. For example, the code 1035 may include instructions executable by the at least one processor 1040 to cause the device 1005 to perform various aspects of location updates for paging monitoring as described herein, or the at least one processor 1040 and the at least one memory 1030 may be otherwise configured to, individually or collectively, perform or support such operations.

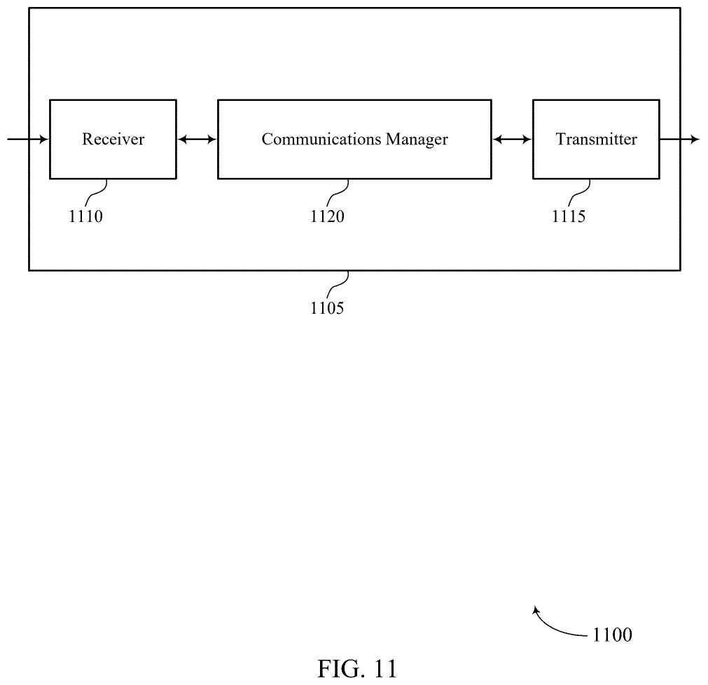

FIG. 11 shows a block diagram 1100 of a device 1105 that supports location updates for paging monitoring in accordance with one or more aspects of the present disclosure. The device 1105 may be an example of aspects of a network entity 105 as described herein. The device 1105 may include a receiver 1110, a transmitter 1115, and a communications manager 1120. The device 1105, or one or more components of the device 1105 (e.g., the receiver 1110, the transmitter 1115, the communications manager 1120), may include at least one processor, which may be coupled with at least one memory, to, individually or collectively, support or enable the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The communications manager 1120, the receiver 1110, the transmitter 1115, or various combinations or components thereof may be examples of means for performing various aspects of location updates for paging monitoring as described herein. For example, the communications manager 1120, the receiver 1110, the transmitter 1115, or various combinations or components thereof may be capable of performing one or more of the functions described herein.

In some examples, the communications manager 1120, the receiver 1110, the transmitter 1115, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1120, the receiver 1110, the transmitter 1115, or various combinations or components thereof may be implemented in code (e.g., as communications management software or firmware) executed by at least one processor (e.g., referred to as a processor-executable code). If implemented in code executed by at least one processor, the functions of the communications manager 1120, the receiver 1110, the transmitter 1115, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications in accordance with examples as disclosed herein. For example, the communications manager 1120 is capable of, configured to, or operable to support a means for outputting, via a first cell, a message including information about one or more other cells in a coverage area of the first cell, where one or more other cells in the coverage area are configured with a network energy savings mode. The communications manager 1120 is capable of, configured to, or operable to support a means for obtaining, from a UE and via a second cell in the coverage area, an on-demand system information request including a unique identifier for the UE. The communications manager 1120 is capable of, configured to, or operable to support a means for outputting, via the second cell, a message including system information. The communications manager 1120 is capable of, configured to, or operable to support a means for outputting, via a first paging channel associated with a first SSB identifier of the second cell, one or more paging messages based on the on-demand system information request.

Additionally, or alternatively, the communications manager 1120 may support wireless communications in accordance with examples as disclosed herein. For example, the communications manager 1120 is capable of, configured to, or operable to support a means for obtaining, from a UE, a message that requests system information and identifies the UE via a UE identifier. The communications manager 1120 is capable of, configured to, or operable to support a means for generating, based on a trigger condition, a paging message for the UE. The communications manager 1120 is capable of, configured to, or operable to support a means for outputting, to the UE while the UE is in an idle mode, the paging message via a paging channel associated with a first SSB identifier associated with a first cell of a set of multiple cells.

By including or configuring the communications manager 1120 in accordance with examples as described herein, the device 1105 (e.g., at least one processor controlling or otherwise coupled with the receiver 1110, the transmitter 1115, the communications manager 1120, or a combination thereof) may support techniques for reduced processing, reduced power consumption, and more efficient utilization of communication resources.

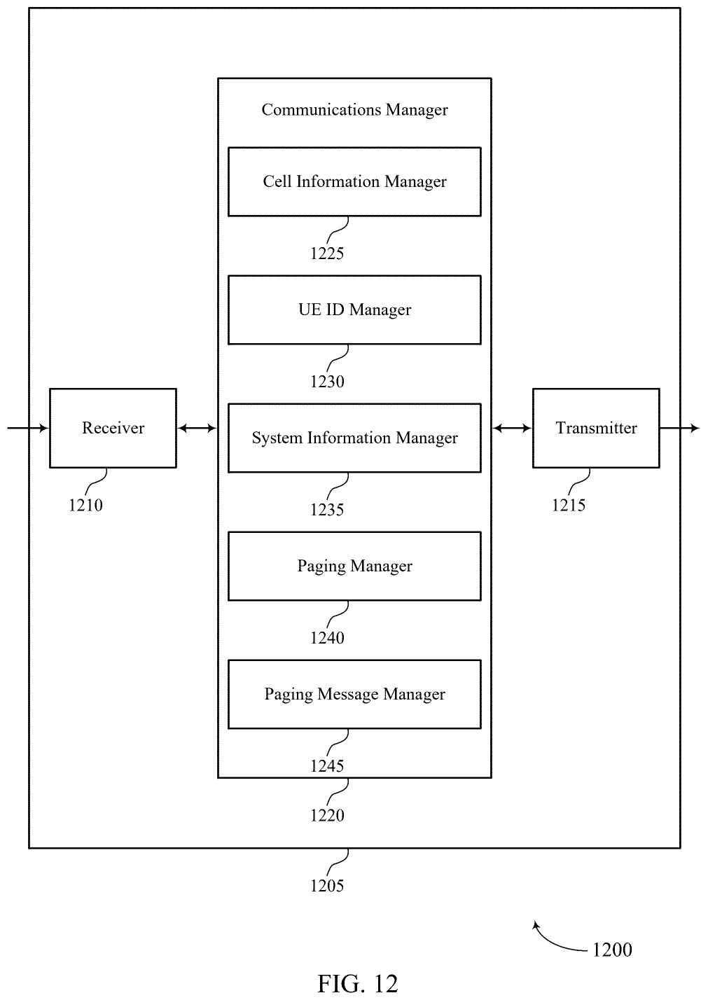

FIG. 12 shows a block diagram 1200 of a device 1205 that supports location updates for paging monitoring in accordance with one or more aspects of the present disclosure. The device 1205 may be an example of aspects of a device 1105 or a network entity 105 as described herein. The device 1205 may include a receiver 1210, a transmitter 1215, and a communications manager 1220. The device 1205, or one or more components of the device 1205 (e.g., the receiver 1210, the transmitter 1215, the communications manager 1220), may include at least one processor, which may be coupled with at least one memory, to support the described techniques. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The device 1205, or various components thereof, may be an example of means for performing various aspects of location updates for paging monitoring as described herein. For example, the communications manager 1220 may include a cell information manager 1225, a UE ID manager 1230, a system information manager 1235, a paging manager 1240, a paging message manager 1245, or any combination thereof. The communications manager 1220 may be an example of aspects of a communications manager 1120 as described herein. In some examples, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communications in accordance with examples as disclosed herein. The cell information manager 1225 is capable of, configured to, or operable to support a means for outputting, via a first cell, a message including information about one or more other cells in a coverage area of the first cell, where one or more other cells in the coverage area are configured with a network energy savings mode. The UE ID manager 1230 is capable of, configured to, or operable to support a means for obtaining, from a UE and via a second cell in the coverage area, an on-demand system information request including a unique identifier for the UE. The system information manager 1235 is capable of, configured to, or operable to support a means for outputting, via the second cell, a message including system information. The paging manager 1240 is capable of, configured to, or operable to support a means for outputting, via a first paging channel associated with a first SSB identifier of the second cell, one or more paging messages based on the on-demand system information request.

Additionally, or alternatively, the communications manager 1220 may support wireless communications in accordance with examples as disclosed herein. The UE ID manager 1230 is capable of, configured to, or operable to support a means for obtaining, from a UE, a message that requests system information and identifies the UE via a UE identifier. The paging message manager 1245 is capable of, configured to, or operable to support a means for generating, based on a trigger condition, a paging message for the UE. The paging manager 1240 is capable of, configured to, or operable to support a means for outputting, to the UE while the UE is in an idle mode, the paging message via a paging channel associated with a first SSB identifier associated with a first cell of a set of multiple cells.

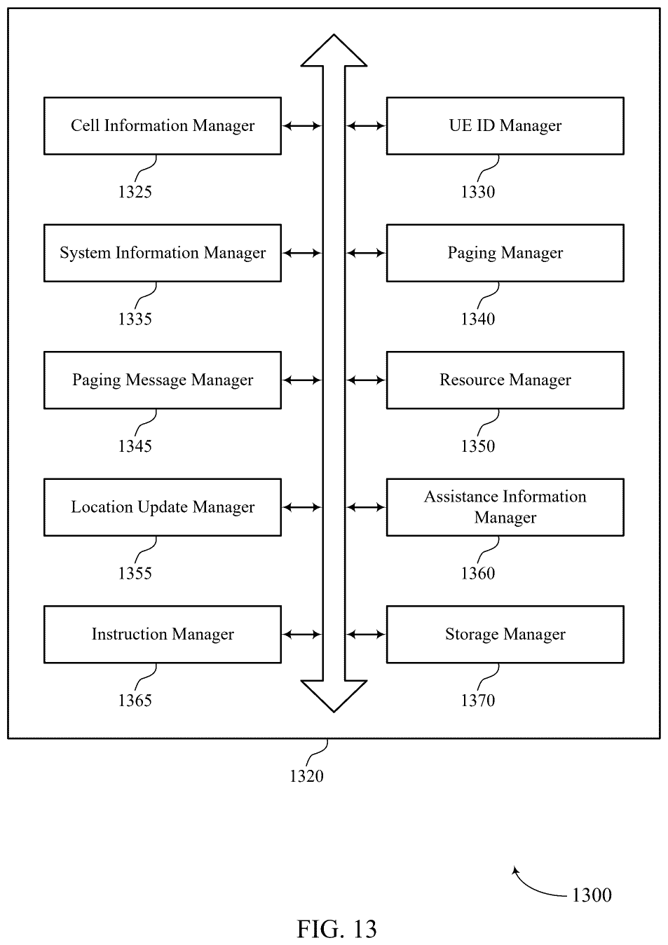

FIG. 13 shows a block diagram 1300 of a communications manager 1320 that supports location updates for paging monitoring in accordance with one or more aspects of the present disclosure. The communications manager 1320 may be an example of aspects of a communications manager 1120, a communications manager 1220, or both, as described herein. The communications manager 1320, or various components thereof, may be an example of means for performing various aspects of location updates for paging monitoring as described herein. For example, the communications manager 1320 may include a cell information manager 1325, a UE ID manager 1330, a system information manager 1335, a paging manager 1340, a paging message manager 1345, a resource manager 1350, a location update manager 1355, an assistance information manager 1360, an instruction manager 1365, a storage manager 1370, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1320 may support wireless communications in accordance with examples as disclosed herein. The cell information manager 1325 is capable of, configured to, or operable to support a means for outputting, via a first cell, a message including information about one or more other cells in a coverage area of the first cell, where one or more other cells in the coverage area are configured with a network energy savings mode. The UE ID manager 1330 is capable of, configured to, or operable to support a means for obtaining, from a UE and via a second cell in the coverage area, an on-demand system information request including a unique identifier for the UE. The system information manager 1335 is capable of, configured to, or operable to support a means for outputting, via the second cell, a message including system information. The paging manager 1340 is capable of, configured to, or operable to support a means for outputting, via a first paging channel associated with a first SSB identifier of the second cell, one or more paging messages based on the on-demand system information request.

In some examples, the resource manager 1350 is capable of, configured to, or operable to support a means for outputting an indication of one or more resources for a location update message, the one or more resources dedicated for the UE and associated with at least a second SSB identifier of the second cell. In some examples, the location update manager 1355 is capable of, configured to, or operable to support a means for obtaining, via the one or more resources associated with the second SSB identifier, the location update message. In some examples, the paging manager 1340 is capable of, configured to, or operable to support a means for outputting, based on the location update message and via a second paging channel associated with the second SSB identifier, one or more paging messages for the UE.

In some examples, the paging manager 1340 is capable of, configured to, or operable to support a means for refraining from outputting one or more paging messages via the first paging channel associated with the first SSB identifier based on the location update message.

In some examples, the one or more resources are associated with a dedicated RAPID.

In some examples, the one or more resources include two or more adjacent transmission beams, each adjacent transmission beam associated with a respective SSB identifier.

In some examples, the location update manager 1355 is capable of, configured to, or operable to support a means for outputting an indication of whether the location update message is associated with a system information request, an SSB request, or a random access channel request, where obtaining the location update message is based on the indication.

In some examples, the unique identifier for the UE is a TMSI or an I-RNTI based on an RRC mode of the UE.

In some examples, the on-demand system information request includes an OD-SIB1, an OD-OSI, an SSB, or a RACH.

Additionally, or alternatively, the communications manager 1320 may support wireless communications in accordance with examples as disclosed herein. In some examples, the UE ID manager 1330 is capable of, configured to, or operable to support a means for obtaining, from a UE, a message that requests system information and identifies the UE via a UE identifier. The paging message manager 1345 is capable of, configured to, or operable to support a means for generating, based on a trigger condition, a paging message for the UE. In some examples, the paging manager 1340 is capable of, configured to, or operable to support a means for outputting, to the UE while the UE is in an idle mode, the paging message via a paging channel associated with a first SSB identifier associated with a first cell of a set of multiple cells.

In some examples, the assistance information manager 1360 is capable of, configured to, or operable to support a means for forwarding the message, assistance information, or both to a network entity. In some examples, the instruction manager 1365 is capable of, configured to, or operable to support a means for obtaining, from the network entity and based on forwarding the message, instructions to page the UE via the first cell of the set of multiple cells, where outputting the paging message is based on the instructions.

In some examples, the assistance information includes cell identifier information, coverage area information, beam information, timing information associated with the message that requests system information, or a combination thereof.

In some examples, the storage manager 1370 is capable of, configured to, or operable to support a means for storing the UE identifier identifying the UE, assistance information, or both. In some examples, the instruction manager 1365 is capable of, configured to, or operable to support a means for obtaining, from a network entity, instructions to page the UE via the first cell of the set of multiple cells, where outputting the paging message is based on the instructions and based on the stored UE identifier.

In some examples, to support receiving instructions from the network entity, the cell information manager 1325 is capable of, configured to, or operable to support a means for obtaining, from the network entity, an indication of a set of multiple cells in a coverage area, where outputting the paging message is based on the indication of the set of multiple cells and based on a cell identifier associated with the UE identifier.

In some examples, the assistance information includes cell identifier information, coverage area information, beam information, timing information associated with the message that requests system information, or a combination thereof.

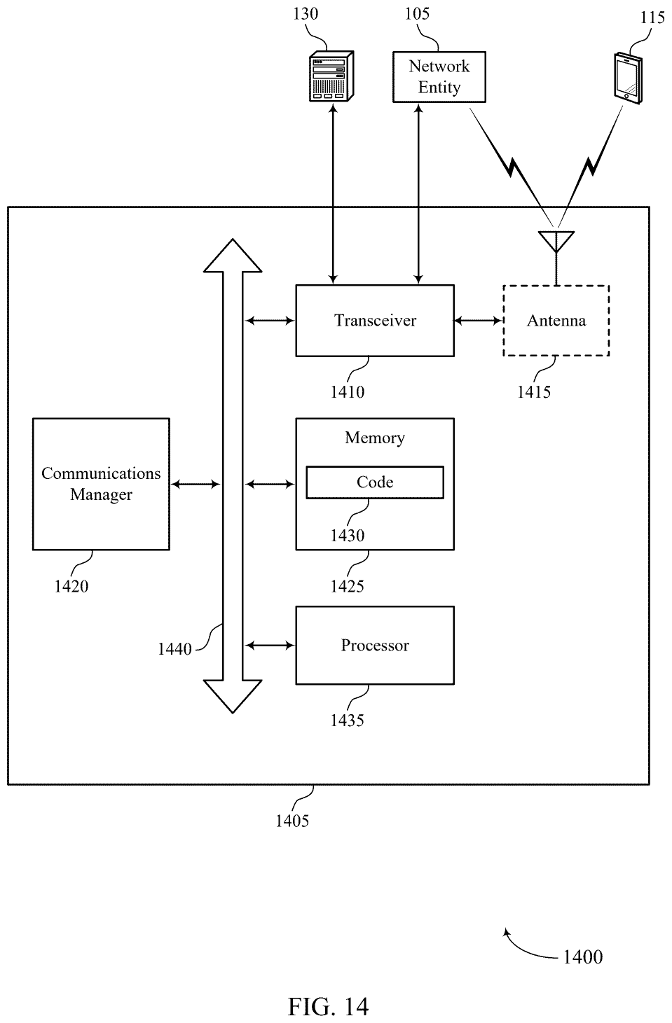

FIG. 14 shows a diagram of a system 1400 including a device 1405 that supports location updates for paging monitoring in accordance with one or more aspects of the present disclosure. The device 1405 may be an example of or include components of a device 1105, a device 1205, or a network entity 105 as described herein. The device 1405 may communicate with other network devices or network equipment such as one or more of the network entities 105, UEs 115, or any combination thereof. The communications may include communications over one or more wired interfaces, over one or more wireless interfaces, or any combination thereof. The device 1405 may include components that support outputting and obtaining communications, such as a communications manager 1420, a transceiver 1410, one or more antennas 1415, at least one memory 1425, code 1430, and at least one processor 1435. These components may be in electronic communication or otherwise coupled (e.g., operatively, communicatively, functionally, electronically, electrically) via one or more buses (e.g., a bus 1440).

The transceiver 1410 may support bi-directional communications via wired links, wireless links, or both as described herein. In some examples, the transceiver 1410 may include a wired transceiver and may communicate bi-directionally with another wired transceiver. Additionally, or alternatively, in some examples, the transceiver 1410 may include a wireless transceiver and may communicate bi-directionally with another wireless transceiver. In some examples, the device 1405 may include one or more antennas 1415, which may be capable of transmitting or receiving wireless transmissions (e.g., concurrently). The transceiver 1410 may also include a modem to modulate signals, to provide the modulated signals for transmission (e.g., by one or more antennas 1415, by a wired transmitter), to receive modulated signals (e.g., from one or more antennas 1415, from a wired receiver), and to demodulate signals. In some implementations, the transceiver 1410 may include one or more interfaces, such as one or more interfaces coupled with the one or more antennas 1415 that are configured to support various receiving or obtaining operations, or one or more interfaces coupled with the one or more antennas 1415 that are configured to support various transmitting or outputting operations, or a combination thereof. In some implementations, the transceiver 1410 may include or be configured for coupling with one or more processors or one or more memory components that are operable to perform or support operations based on received or obtained information or signals, or to generate information or other signals for transmission or other outputting, or any combination thereof. In some implementations, the transceiver 1410, or the transceiver 1410 and the one or more antennas 1415, or the transceiver 1410 and the one or more antennas 1415 and one or more processors or one or more memory components (e.g., the at least one processor 1435, the at least one memory 1425, or both), may be included in a chip or chip assembly that is installed in the device 1405. In some examples, the transceiver 1410 may be operable to support communications via one or more communications links (e.g., communication link(s) 125, backhaul communication link(s) 120, a midhaul communication link 162, a fronthaul communication link 168).

The at least one memory 1425 may include RAM, ROM, or any combination thereof. The at least one memory 1425 may store computer-readable, computer-executable, or processor-executable code, such as the code 1430. The code 1430 may include instructions that, when executed by one or more of the at least one processor 1435, cause the device 1405 to perform various functions described herein. The code 1430 may be stored in a non-transitory computer-readable medium such as system memory or another type of memory. In some cases, the code 1430 may not be directly executable by a processor of the at least one processor 1435 but may cause a computer (e.g., when compiled and executed) to perform functions described herein. In some cases, the at least one memory 1425 may include, among other things, a BIOS which may control basic hardware or software operation such as the interaction with peripheral components or devices. In some examples, the at least one processor 1435 may include multiple processors and the at least one memory 1425 may include multiple memories. One or more of the multiple processors may be coupled with one or more of the multiple memories which may, individually or collectively, be configured to perform various functions herein (for example, as part of a processing system).

The at least one processor 1435 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1435 may be configured to operate a memory array using a memory controller. In some other cases, a memory controller may be integrated into one or more of the at least one processor 1435. The at least one processor 1435 may be configured to execute computer-readable instructions stored in a memory (e.g., one or more of the at least one memory 1425) to cause the device 1405 to perform various functions (e.g., functions or tasks supporting location updates for paging monitoring). For example, the device 1405 or a component of the device 1405 may include at least one processor 1435 and at least one memory 1425 coupled with one or more of the at least one processor 1435, the at least one processor 1435 and the at least one memory 1425 configured to perform various functions described herein. The at least one processor 1435 may be an example of a cloud-computing platform (e.g., one or more physical nodes and supporting software such as operating systems, virtual machines, or container instances) that may host the functions (e.g., by executing code 1430) to perform the functions of the device 1405. The at least one processor 1435 may be any one or more suitable processors capable of executing scripts or instructions of one or more software programs stored in the device 1405 (such as within one or more of the at least one memory 1425).

In some examples, the at least one processor 1435 may include multiple processors and the at least one memory 1425 may include multiple memories. One or more of the multiple processors may be coupled with one or more of the multiple memories, which may, individually or collectively, be configured to perform various functions herein. In some examples, the at least one processor 1435 may be a component of a processing system, which may refer to a system (such as a series) of machines, circuitry (including, for example, one or both of processor circuitry (which may include the at least one processor 1435) and memory circuitry (which may include the at least one memory 1425)), or components, that receives or obtains inputs and processes the inputs to produce, generate, or obtain a set of outputs. The processing system may be configured to perform one or more of the functions described herein. For example, the at least one processor 1435 or a processing system including the at least one processor 1435 may be configured to, configurable to, or operable to cause the device 1405 to perform one or more of the functions described herein. Further, as described herein, being “configured to,” being “configurable to,” and being “operable to” may be used interchangeably and may be associated with a capability, when executing code stored in the at least one memory 1425 or otherwise, to perform one or more of the functions described herein.

In some examples, a bus 1440 may support communications of (e.g., within) a protocol layer of a protocol stack. In some examples, a bus 1440 may support communications associated with a logical channel of a protocol stack (e.g., between protocol layers of a protocol stack), which may include communications performed within a component of the device 1405, or between different components of the device 1405 that may be co-located or located in different locations (e.g., where the device 1405 may refer to a system in which one or more of the communications manager 1420, the transceiver 1410, the at least one memory 1425, the code 1430, and the at least one processor 1435 may be located in one of the different components or divided between different components).

In some examples, the communications manager 1420 may manage aspects of communications with a core network 130 (e.g., via one or more wired or wireless backhaul links). For example, the communications manager 1420 may manage the transfer of data communications for client devices, such as one or more UEs 115. In some examples, the communications manager 1420 may manage communications with one or more other network entities 105, and may include a controller or scheduler for controlling communications with UEs 115 (e.g., in cooperation with the one or more other network devices). In some examples, the communications manager 1420 may support an X2 interface within an LTE/LTE-A wireless communications network technology to provide communication between network entities 105.

The communications manager 1420 may support wireless communications in accordance with examples as disclosed herein. For example, the communications manager 1420 is capable of, configured to, or operable to support a means for outputting, via a first cell, a message including information about one or more other cells in a coverage area of the first cell, where one or more other cells in the coverage area are configured with a network energy savings mode. The communications manager 1420 is capable of, configured to, or operable to support a means for obtaining, from a UE and via a second cell in the coverage area, an on-demand system information request including a unique identifier for the UE. The communications manager 1420 is capable of, configured to, or operable to support a means for outputting, via the second cell, a message including system information. The communications manager 1420 is capable of, configured to, or operable to support a means for outputting, via a first paging channel associated with a first SSB identifier of the second cell, one or more paging messages based on the on-demand system information request.

Additionally, or alternatively, the communications manager 1420 may support wireless communications in accordance with examples as disclosed herein. For example, the communications manager 1420 is capable of, configured to, or operable to support a means for obtaining, from a UE, a message that requests system information and identifies the UE via a UE identifier. The communications manager 1420 is capable of, configured to, or operable to support a means for generating, based on a trigger condition, a paging message for the UE. The communications manager 1420 is capable of, configured to, or operable to support a means for outputting, to the UE while the UE is in an idle mode, the paging message via a paging channel associated with a first SSB identifier associated with a first cell of a set of multiple cells.

By including or configuring the communications manager 1420 in accordance with examples as described herein, the device 1405 may support techniques for reduced latency, improved user experience related to reduced processing, reduced power consumption, more efficient utilization of communication resources, improved coordination between devices, and longer battery life.

In some examples, the communications manager 1420 may be configured to perform various operations (e.g., receiving, obtaining, monitoring, outputting, transmitting) using or otherwise in cooperation with the transceiver 1410, the one or more antennas 1415 (e.g., where applicable), or any combination thereof. Although the communications manager 1420 is illustrated as a separate component, in some examples, one or more functions described with reference to the communications manager 1420 may be supported by or performed by the transceiver 1410, one or more of the at least one processor 1435, one or more of the at least one memory 1425, the code 1430, or any combination thereof (for example, by a processing system including at least a portion of the at least one processor 1435, the at least one memory 1425, the code 1430, or any combination thereof). For example, the code 1430 may include instructions executable by one or more of the at least one processor 1435 to cause the device 1405 to perform various aspects of location updates for paging monitoring as described herein, or the at least one processor 1435 and the at least one memory 1425 may be otherwise configured to, individually or collectively, perform or support such operations.

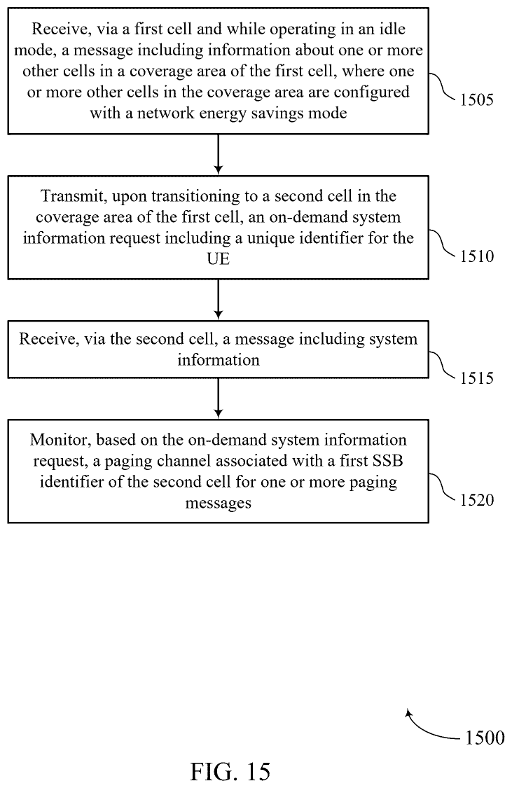

FIG. 15 shows a flowchart illustrating a method 1500 that supports location updates for paging monitoring in accordance with one or more aspects of the present disclosure. The operations of the method 1500 may be implemented by a UE or its components as described herein. For example, the operations of the method 1500 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1505, the method may include receiving, via a first cell and while operating in an idle mode, a message including information about one or more other cells in a coverage area of the first cell, where one or more other cells in the coverage area are configured with a network energy savings mode. The operations of 1505 may be performed in accordance with examples as disclosed herein. In some examples, aspects of the operations of 1505 may be performed by a cell information component 925 as described with reference to FIG. 9.

At 1510, the method may include transmitting, upon transitioning to a second cell in the coverage area of the first cell, an on-demand system information request including a unique identifier for the UE. The operations of 1510 may be performed in accordance with examples as disclosed herein. In some examples, aspects of the operations of 1510 may be performed by a UE ID component 930 as described with reference to FIG. 9.

At 1515, the method may include receiving, via the second cell, a message including system information. The operations of 1515 may be performed in accordance with examples as disclosed herein. In some examples, aspects of the operations of 1515 may be performed by a system information component 935 as described with reference to FIG. 9.

At 1520, the method may include monitoring, based on the on-demand system information request, a paging channel associated with a first SSB identifier of the second cell for one or more paging messages. The operations of 1520 may be performed in accordance with examples as disclosed herein. In some examples, aspects of the operations of 1520 may be performed by a paging component 940 as described with reference to FIG. 9.

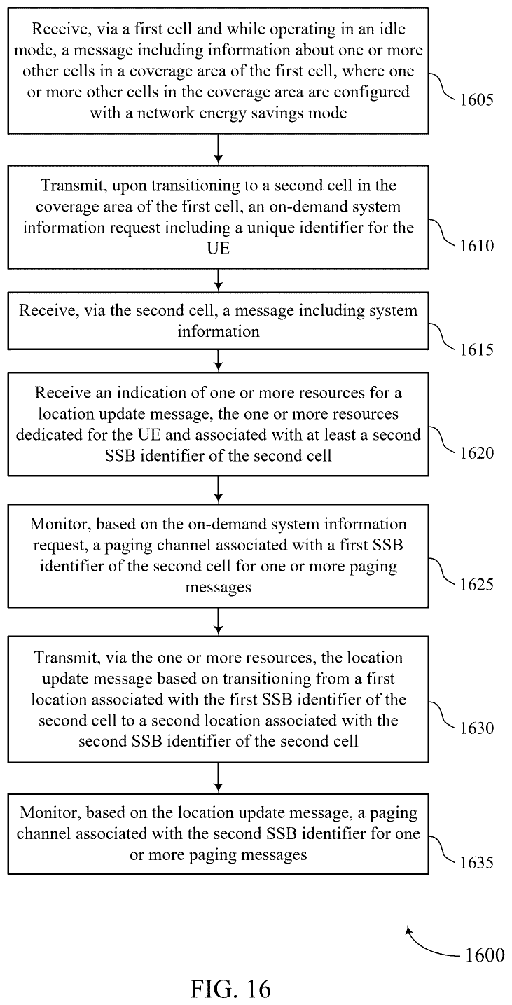

FIG. 16 shows a flowchart illustrating a method 1600 that supports location updates for paging monitoring in accordance with one or more aspects of the present disclosure. The operations of the method 1600 may be implemented by a UE or its components as described herein. For example, the operations of the method 1600 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1605, the method may include receiving, via a first cell and while operating in an idle mode, a message including information about one or more other cells in a coverage area of the first cell, where one or more other cells in the coverage area are configured with a network energy savings mode. The operations of 1605 may be performed in accordance with examples as disclosed herein. In some examples, aspects of the operations of 1605 may be performed by a cell information component 925 as described with reference to FIG. 9.

At 1610, the method may include transmitting, upon transitioning to a second cell in the coverage area of the first cell, an on-demand system information request including a unique identifier for the UE. The operations of 1610 may be performed in accordance with examples as disclosed herein. In some examples, aspects of the operations of 1610 may be performed by a UE ID component 930 as described with reference to FIG. 9.

At 1615, the method may include receiving, via the second cell, a message including system information. The operations of 1615 may be performed in accordance with examples as disclosed herein. In some examples, aspects of the operations of 1615 may be performed by a system information component 935 as described with reference to FIG. 9.

At 1620, the method may include receiving an indication of one or more resources for a location update message, the one or more resources dedicated for the UE and associated with at least a second SSB identifier of the second cell. The operations of 1620 may be performed in accordance with examples as disclosed herein. In some examples, aspects of the operations of 1620 may be performed by a resource component 945 as described with reference to FIG. 9.

At 1625, the method may include monitoring, based on the on-demand system information request, a paging channel associated with a first SSB identifier of the second cell for one or more paging messages. The operations of 1625 may be performed in accordance with examples as disclosed herein. In some examples, aspects of the operations of 1625 may be performed by a paging component 940 as described with reference to FIG. 9.

At 1630, the method may include transmitting, via the one or more resources, the location update message based on transitioning from a first location associated with the first SSB identifier of the second cell to a second location associated with the second SSB identifier of the second cell. The operations of 1630 may be performed in accordance with examples as disclosed herein. In some examples, aspects of the operations of 1630 may be performed by a location update component 950 as described with reference to FIG. 9.

At 1635, the method may include monitoring, based on the location update message, a paging channel associated with the second SSB identifier for one or more paging messages. The operations of 1635 may be performed in accordance with examples as disclosed herein. In some examples, aspects of the operations of 1635 may be performed by a paging component 940 as described with reference to FIG. 9.

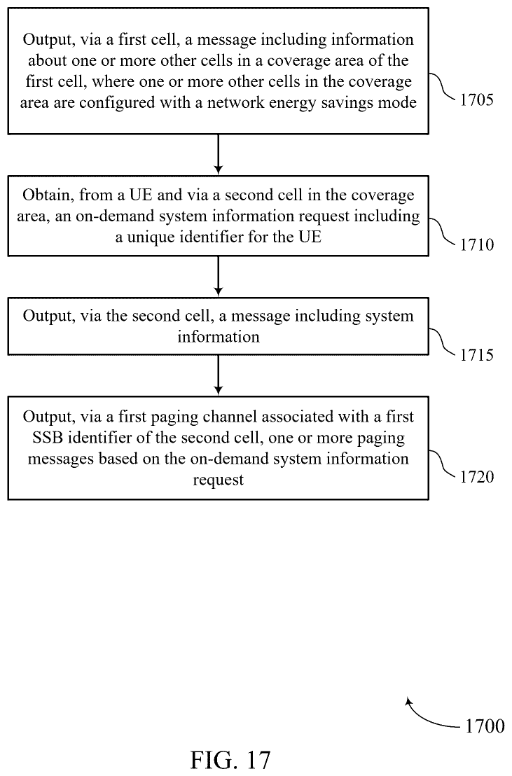

FIG. 17 shows a flowchart illustrating a method 1700 that supports location updates for paging monitoring in accordance with one or more aspects of the present disclosure. The operations of the method 1700 may be implemented by a network entity or its components as described herein. For example, the operations of the method 1700 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 1705, the method may include outputting, via a first cell, a message including information about one or more other cells in a coverage area of the first cell, where one or more other cells in the coverage area are configured with a network energy savings mode. The operations of 1705 may be performed in accordance with examples as disclosed herein. In some examples, aspects of the operations of 1705 may be performed by a cell information manager 1325 as described with reference to FIG. 13.

At 1710, the method may include obtaining, from a UE and via a second cell in the coverage area, an on-demand system information request including a unique identifier for the UE. The operations of 1710 may be performed in accordance with examples as disclosed herein. In some examples, aspects of the operations of 1710 may be performed by a UE ID manager 1330 as described with reference to FIG. 13.

At 1715, the method may include outputting, via the second cell, a message including system information. The operations of 1715 may be performed in accordance with examples as disclosed herein. In some examples, aspects of the operations of 1715 may be performed by a system information manager 1335 as described with reference to FIG. 13.

At 1720, the method may include outputting, via a first paging channel associated with a first SSB identifier of the second cell, one or more paging messages based on the on-demand system information request. The operations of 1720 may be performed in accordance with examples as disclosed herein. In some examples, aspects of the operations of 1720 may be performed by a paging manager 1340 as described with reference to FIG. 13.

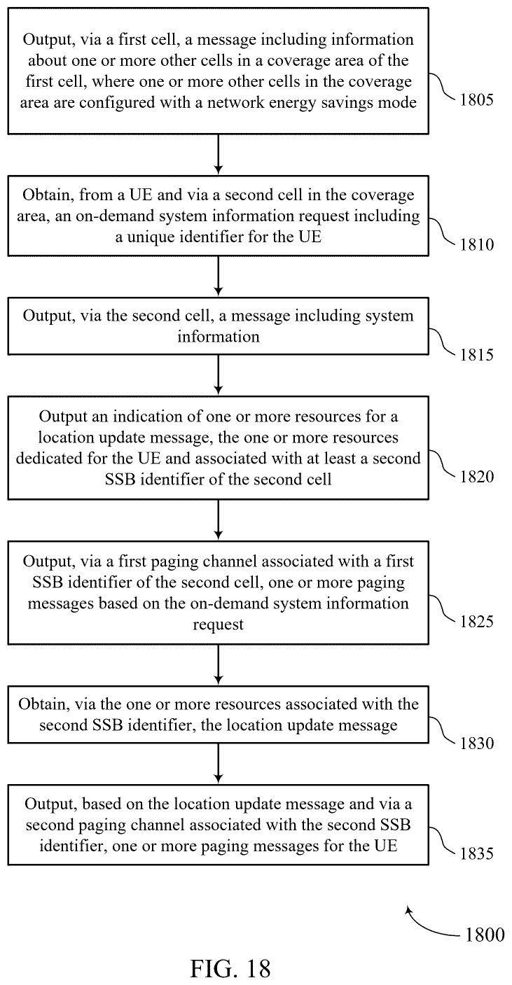

FIG. 18 shows a flowchart illustrating a method 1800 that supports location updates for paging monitoring in accordance with one or more aspects of the present disclosure. The operations of the method 1800 may be implemented by a network entity or its components as described herein. For example, the operations of the method 1800 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 1805, the method may include outputting, via a first cell, a message including information about one or more other cells in a coverage area of the first cell, where one or more other cells in the coverage area are configured with a network energy savings mode. The operations of 1805 may be performed in accordance with examples as disclosed herein. In some examples, aspects of the operations of 1805 may be performed by a cell information manager 1325 as described with reference to FIG. 13.

At 1810, the method may include obtaining, from a UE and via a second cell in the coverage area, an on-demand system information request including a unique identifier for the UE. The operations of 1810 may be performed in accordance with examples as disclosed herein. In some examples, aspects of the operations of 1810 may be performed by a UE ID manager 1330 as described with reference to FIG. 13.

At 1815, the method may include outputting, via the second cell, a message including system information. The operations of 1815 may be performed in accordance with examples as disclosed herein. In some examples, aspects of the operations of 1815 may be performed by a system information manager 1335 as described with reference to FIG. 13.

At 1820, the method may include outputting an indication of one or more resources for a location update message, the one or more resources dedicated for the UE and associated with at least a second SSB identifier of the second cell. The operations of 1820 may be performed in accordance with examples as disclosed herein. In some examples, aspects of the operations of 1820 may be performed by a resource manager 1350 as described with reference to FIG. 13.

At 1825, the method may include outputting, via a first paging channel associated with a first SSB identifier of the second cell, one or more paging messages based on the on-demand system information request. The operations of 1825 may be performed in accordance with examples as disclosed herein. In some examples, aspects of the operations of 1825 may be performed by a paging manager 1340 as described with reference to FIG. 13.

At 1830, the method may include obtaining, via the one or more resources associated with the second SSB identifier, the location update message. The operations of 1830 may be performed in accordance with examples as disclosed herein. In some examples, aspects of the operations of 1830 may be performed by a location update manager 1355 as described with reference to FIG. 13.

At 1835, the method may include outputting, based on the location update message and via a second paging channel associated with the second SSB identifier, one or more paging messages for the UE. The operations of 1835 may be performed in accordance with examples as disclosed herein. In some examples, aspects of the operations of 1835 may be performed by a paging manager 1340 as described with reference to FIG. 13.

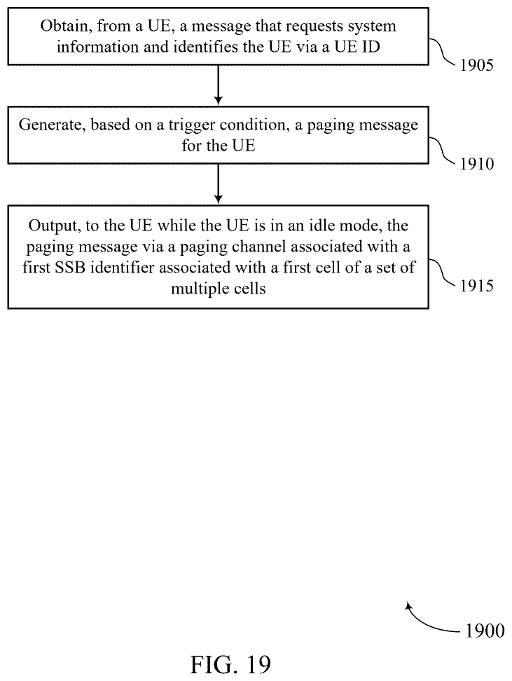

FIG. 19 shows a flowchart illustrating a method 1900 that supports location updates for paging monitoring in accordance with one or more aspects of the present disclosure. The operations of the method 1900 may be implemented by a network entity or its components as described herein. For example, the operations of the method 1900 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 1905, the method may include obtaining, from a UE, a message that requests system information and identifies the UE via a UE identifier. The operations of 1905 may be performed in accordance with examples as disclosed herein. In some examples, aspects of the operations of 1905 may be performed by a UE ID manager 1330 as described with reference to FIG. 13.

At 1910, the method may include generating, based on a trigger condition, a paging message for the UE. The operations of 1910 may be performed in accordance with examples as disclosed herein. In some examples, aspects of the operations of 1910 may be performed by a paging message manager 1345 as described with reference to FIG. 13.

At 1915, the method may include outputting, to the UE while the UE is in an idle mode, the paging message via a paging channel associated with a first SSB identifier associated with a first cell of a set of multiple cells. The operations of 1915 may be performed in accordance with examples as disclosed herein. In some examples, aspects of the operations of 1915 may be performed by a paging manager 1340 as described with reference to FIG. 13.

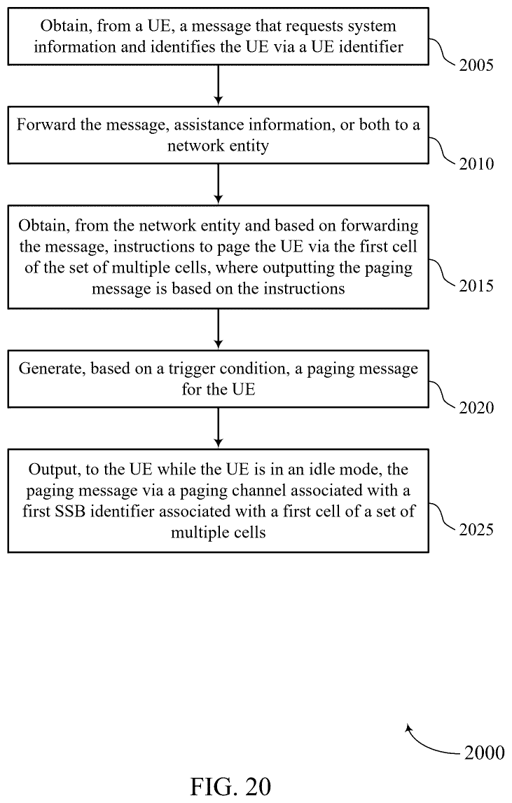

FIG. 20 shows a flowchart illustrating a method 2000 that supports location updates for paging monitoring in accordance with one or more aspects of the present disclosure. The operations of the method 2000 may be implemented by a network entity or its components as described herein. For example, the operations of the method 2000 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 2005, the method may include obtaining, from a UE, a message that requests system information and identifies the UE via a UE identifier. The operations of 2005 may be performed in accordance with examples as disclosed herein. In some examples, aspects of the operations of 2005 may be performed by a UE ID manager 1330 as described with reference to FIG. 13.

At 2010, the method may include forwarding the message, assistance information, or both to a network entity. The operations of 2010 may be performed in accordance with examples as disclosed herein. In some examples, aspects of the operations of 2010 may be performed by an assistance information manager 1360 as described with reference to FIG. 13.

At 2015, the method may include obtaining, from the network entity and based on forwarding the message, instructions to page the UE via the first cell of the set of multiple cells, where outputting the paging message is based on the instructions. The operations of 2015 may be performed in accordance with examples as disclosed herein. In some examples, aspects of the operations of 2015 may be performed by an instruction manager 1365 as described with reference to FIG. 13.

At 2020, the method may include generating, based on a trigger condition, a paging message for the UE. The operations of 2020 may be performed in accordance with examples as disclosed herein. In some examples, aspects of the operations of 2020 may be performed by a paging message manager 1345 as described with reference to FIG. 13.

At 2025, the method may include outputting, to the UE while the UE is in an idle mode, the paging message via a paging channel associated with a first SSB identifier associated with a first cell of a set of multiple cells. The operations of 2025 may be performed in accordance with examples as disclosed herein. In some examples, aspects of the operations of 2025 may be performed by a paging manager 1340 as described with reference to FIG. 13.

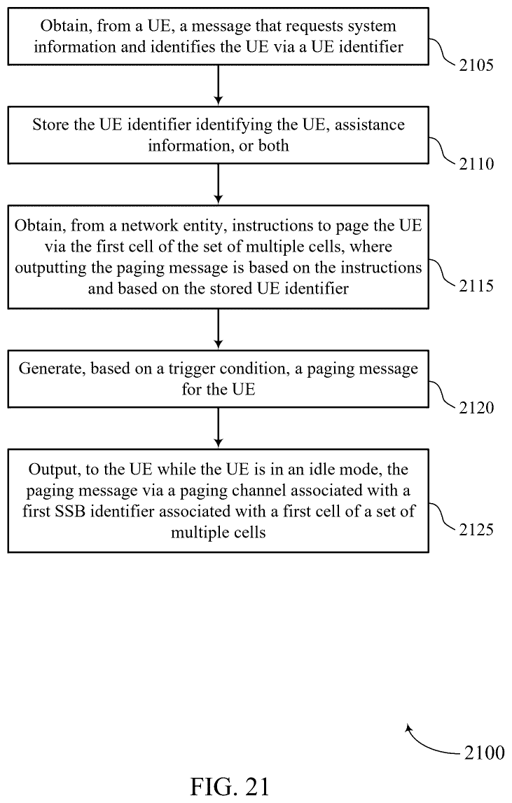

FIG. 21 shows a flowchart illustrating a method 2100 that supports location updates for paging monitoring in accordance with one or more aspects of the present disclosure. The operations of the method 2100 may be implemented by a network entity or its components as described herein. For example, the operations of the method 2100 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 2105, the method may include obtaining, from a UE, a message that requests system information and identifies the UE via a UE identifier. The operations of 2105 may be performed in accordance with examples as disclosed herein. In some examples, aspects of the operations of 2105 may be performed by a UE ID manager 1330 as described with reference to FIG. 13.

At 2110, the method may include storing the UE identifier identifying the UE, assistance information, or both. The operations of 2110 may be performed in accordance with examples as disclosed herein. In some examples, aspects of the operations of 2110 may be performed by a storage manager 1370 as described with reference to FIG. 13.

At 2115, the method may include obtaining, from a network entity, instructions to page the UE via the first cell of the set of multiple cells, where outputting the paging message is based on the instructions and based on the stored UE identifier. The operations of 2115 may be performed in accordance with examples as disclosed herein. In some examples, aspects of the operations of 2115 may be performed by an instruction manager 1365 as described with reference to FIG. 13.

At 2120, the method may include generating, based on a trigger condition, a paging message for the UE. The operations of 2120 may be performed in accordance with examples as disclosed herein. In some examples, aspects of the operations of 2120 may be performed by a paging message manager 1345 as described with reference to FIG. 13.

At 2125, the method may include outputting, to the UE while the UE is in an idle mode, the paging message via a paging channel associated with a first SSB identifier associated with a first cell of a set of multiple cells. The operations of 2125 may be performed in accordance with examples as disclosed herein. In some examples, aspects of the operations of 2125 may be performed by a paging manager 1340 as described with reference to FIG. 13.

Aspect 1: A method for wireless communications at a UE, comprising: receiving, via a first cell and while operating in an idle mode, a message including information about one or more other cells in a coverage area of the first cell, wherein one or more other cells in the coverage area are configured with a network energy savings mode; transmitting, upon transitioning to a second cell in the coverage area of the first cell, an on-demand system information request comprising a unique identifier for the UE; receiving, via the second cell, a message comprising system information; and monitoring, based at least in part on the on-demand system information request, a paging channel associated with a first synchronization signal block (SSB) identifier of the second cell for one or more paging messages.

Aspect 2: The method of aspect 1, comprising: receiving an indication of one or more resources for a location update message, the one or more resources dedicated for the UE and associated with at least a second SSB identifier of the second cell; transmitting, via the one or more resources, the location update message based at least in part on transitioning from a first location associated with the first SSB identifier of the second cell to a second location associated with the second SSB identifier of the second cell; and monitoring, based at least in part on the location update message, a paging channel associated with the second SSB identifier for one or more paging messages.

Aspect 3: The method of aspect 2, wherein the one or more resources are associated with a dedicated remote access point identifier (RAPID).

Aspect 4: The method of any of aspects 2 through 3, wherein the one or more resources comprise two or more adjacent transmission beams, each adjacent transmission beam associated with a respective SSB identifier.

Aspect 5: The method of any of aspects 2 through 4, further comprising: receiving an indication of whether the location update message is associated with a system information request, an SSB request, or a random access channel request, wherein transmitting the location update message is based at least in part on the indication.

Aspect 6: The method of any of aspects 1 through 5, wherein the unique identifier for the UE is a temporary mobile subscriber identifier (TMSI) or an inactive radio network temporary identifier (I-RNTI) based at least in part on an RRC mode of the UE.

Aspect 7: The method of any of aspects 1 through 6, wherein the on-demand system information request comprises an on-demand system information block 1 (OD-SIB1), an on-demand other system information (OD-OSI), a synchronization signal block (SSB), or a RACH.

Aspect 8: A method for wireless communications, comprising: outputting, via a first cell, a message including information about one or more other cells in a coverage area of the first cell, wherein one or more other cells in the coverage area are configured with a network energy savings mode; obtaining, from a UE and via a second cell in the coverage area, an on-demand system information request comprising a unique identifier for the UE; outputting, via the second cell, a message comprising system information; and outputting, via a first paging channel associated with a first synchronization signal block (SSB) identifier of the second cell, one or more paging messages based at least in part on the on-demand system information request.

Aspect 9: The method of aspect 8, further comprising: outputting an indication of one or more resources for a location update message, the one or more resources dedicated for the UE and associated with at least a second SSB identifier of the second cell; obtaining, via the one or more resources associated with the second SSB identifier, the location update message; and outputting, based at least in part on the location update message and via a second paging channel associated with the second SSB identifier, one or more paging messages for the UE.

Aspect 10: The method of aspect 9, further comprising: refraining from outputting one or more paging messages via the first paging channel associated with the first SSB identifier based at least in part on the location update message.

Aspect 11: The method of any of aspects 9 through 10, wherein the one or more resources are associated with a dedicated remote access point identifier (RAPID).

Aspect 12: The method of any of aspects 9 through 11, wherein the one or more resources comprise two or more adjacent transmission beams, each adjacent transmission beam associated with a respective SSB identifier.

Aspect 13: The method of any of aspects 9 through 12, further comprising: outputting an indication of whether the location update message is associated with a system information request, an SSB request, or a random access channel request, wherein obtaining the location update message is based at least in part on the indication.

Aspect 14: The method of any of aspects 8 through 13, wherein the unique identifier for the UE is a temporary mobile subscriber identifier (TMSI) or an inactive radio network temporary identifier (I-RNTI) based at least in part on an RRC mode of the UE.

Aspect 15: The method of any of aspects 8 through 14, wherein the on-demand system information request comprises an on-demand system information block 1 (OD-SIB1), an on-demand other system information (OD-OSI), a synchronization signal block (SSB), or a RACH.

Aspect 16: A method for wireless communications, comprising: obtaining, from a UE, a message that requests system information and identifies the UE via a UE identifier; generating, based at least in part on a trigger condition, a paging message for the UE; and outputting, to the UE while the UE is in an idle mode, the paging message via a paging channel associated with a first synchronization signal block (SSB) identifier associated with a first cell of a plurality of cells.

Aspect 17: The method of aspect 16, comprising: forwarding the message, assistance information, or both to a network entity; and obtaining, from the network entity and based at least in part on forwarding the message, instructions to page the UE via the first cell of the plurality of cells, wherein outputting the paging message is based at least in part on the instructions.

Aspect 18: The method of aspect 17, wherein the assistance information comprises cell identifier information, coverage area information, beam information, timing information associated with the message that requests system information, or a combination thereof.

Aspect 19: The method of any of aspects 16 through 18, comprising: storing the UE identifier identifying the UE, assistance information, or both; and obtaining, from a network entity, instructions to page the UE via the first cell of the plurality of cells, wherein outputting the paging message is based at least in part on the instructions and based at least in part on the stored UE identifier.

Aspect 20: The method of aspect 19, wherein receiving instructions from the network entity further comprises: obtaining, from the network entity, an indication of a plurality of cells in a coverage area, wherein outputting the paging message is based at least in part on the indication of the plurality of cells and based at least in part on a cell identifier associated with the UE identifier.

Aspect 21: The method of any of aspects 19 through 20, wherein the assistance information comprises cell identifier information, coverage area information, beam information, timing information associated with the message that requests system information, or a combination thereof.

Aspect 22: A UE for wireless communications, comprising one or more memories storing processor-executable code, and one or more processors coupled with the one or more memories and individually or collectively operable to execute the code to cause the UE to perform a method of any of aspects 1 through 7.

Aspect 23: A UE for wireless communications, comprising at least one means for performing a method of any of aspects 1 through 7.

Aspect 24: A non-transitory computer-readable medium storing code for wireless communications, the code comprising instructions executable by one or more processors to perform a method of any of aspects 1 through 7.

Aspect 25: An apparatus for wireless communications, comprising one or more memories storing processor-executable code, and one or more processors coupled with the one or more memories and individually or collectively operable to execute the code to cause the apparatus to perform a method of any of aspects 8 through 15.

Aspect 26: An apparatus for wireless communications, comprising at least one means for performing a method of any of aspects 8 through 15.

Aspect 27: A non-transitory computer-readable medium storing code for wireless communications, the code comprising instructions executable by one or more processors to perform a method of any of aspects 8 through 15.

Aspect 28: An apparatus for wireless communications, comprising one or more memories storing processor-executable code, and one or more processors coupled with the one or more memories and individually or collectively operable to execute the code to cause the apparatus to perform a method of any of aspects 16 through 21.

Aspect 29: An apparatus for wireless communications, comprising at least one means for performing a method of any of aspects 16 through 21.

Aspect 30: A non-transitory computer-readable medium storing code for wireless communications, the code comprising instructions executable by one or more processors to perform a method of any of aspects 16 through 21.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive, via a first cell and while operating in an idle mode, a message including information about one or more other cells in a coverage area of the first cell, wherein one or more other cells in the coverage area are configured with a network energy savings mode;
transmit, upon transitioning to a second cell in the coverage area of the first cell, an on-demand system information request comprising a unique identifier for the UE;
receive, via the second cell, a message comprising system information; and
monitor, based at least in part on the on-demand system information request, a paging channel associated with a first synchronization signal block (SSB) identifier of the second cell for one or more paging messages.

2. The UE of claim 1, wherein the one or more processors are individually or collectively further operable to execute the code to cause the UE to:
receive an indication of one or more resources for a location update message, the one or more resources dedicated for the UE and associated with at least a second SSB identifier of the second cell;
transmit, via the one or more resources, the location update message based at least in part on transitioning from a first location associated with the first SSB identifier of the second cell to a second location associated with the second SSB identifier of the second cell; and
monitor, based at least in part on the location update message, a paging channel associated with the second SSB identifier for one or more paging messages.

3. The UE of claim 2, wherein the one or more resources are associated with a dedicated remote access point identifier (RAPID).

4. The UE of claim 2, wherein the one or more resources comprise two or more adjacent transmission beams, each adjacent transmission beam associated with a respective SSB identifier.

5. The UE of claim 2, wherein the one or more processors are individually or collectively further operable to execute the code to cause the UE to:
receive an indication of whether the location update message is associated with a system information request, an SSB request, or a random access channel request, wherein transmitting the location update message is based at least in part on the indication.

6. The UE of claim 1, wherein the unique identifier for the UE is a temporary mobile subscriber identifier (TMSI) or an inactive radio network temporary identifier (I-RNTI) based at least in part on a radio resource control (RRC) mode of the UE.

7. The UE of claim 1, wherein the on-demand system information request comprises an on-demand system information block 1 (OD-SIB1), an on-demand other system information (OD-OSI), a synchronization signal block (SSB), or a random access channel (RACH).

8. An apparatus, comprising:
one or more memories storing processor-executable code; and
one or more processors coupled with the one or more memories and individually or collectively operable to execute the code to cause the apparatus to:
obtain, from a user equipment (UE), a message that requests system information and identifies the UE via a UE identifier;
generate, based at least in part on a trigger condition, a paging message for the UE; and
output, to the UE while the UE is in an idle mode, the paging message via a paging channel associated with a first synchronization signal block (SSB) identifier associated with a first cell of a plurality of cells.

9. The apparatus of claim 8, wherein the one or more processors are individually or collectively further operable to execute the code to cause the apparatus to:
forward the message, assistance information, or both to a network entity; and
obtain, from the network entity and based at least in part on forwarding the message, instructions to page the UE via the first cell of the plurality of cells, wherein outputting the paging message is based at least in part on the instructions.

10. The apparatus of claim 9, wherein the assistance information comprises cell identifier information, coverage area information, beam information, timing information associated with the message that requests system information, or a combination thereof.

11. The apparatus of claim 8, wherein the one or more processors are individually or collectively further operable to execute the code to cause the apparatus to:
store the UE identifier identifying the UE, assistance information, or both; and
obtain, from a network entity, instructions to page the UE via the first cell of the plurality of cells, wherein outputting the paging message is based at least in part on the instructions and based at least in part on the stored UE identifier.

12. The apparatus of claim 11, wherein, to receive instructions from the network entity, the one or more processors are individually or collectively further operable to execute the code to cause the apparatus to:
obtain, from the network entity, an indication of a plurality of cells in a coverage area, wherein outputting the paging message is based at least in part on the indication of the plurality of cells and based at least in part on a cell identifier associated with the UE identifier.

13. The apparatus of claim 11, wherein the assistance information comprises cell identifier information, coverage area information, beam information, timing information associated with the message that requests system information, or a combination thereof.

14. A method for wireless communications at a user equipment (UE), comprising:
receiving, via a first cell and while operating in an idle mode, a message including information about one or more other cells in a coverage area of the first cell, wherein one or more other cells in the coverage area are configured with a network energy savings mode;
transmitting, upon transitioning to a second cell in the coverage area of the first cell, an on-demand system information request comprising a unique identifier for the UE;
receiving, via the second cell, a message comprising system information; and
monitoring, based at least in part on the on-demand system information request, a paging channel associated with a first synchronization signal block (SSB) identifier of the second cell for one or more paging messages.

15. The method of claim 14, further comprising:
receiving an indication of one or more resources for a location update message, the one or more resources dedicated for the UE and associated with at least a second SSB identifier of the second cell;
transmitting, via the one or more resources, the location update message based at least in part on transitioning from a first location associated with the first SSB identifier of the second cell to a second location associated with the second SSB identifier of the second cell; and
monitoring, based at least in part on the location update message, a paging channel associated with the second SSB identifier for one or more paging messages.

16. The method of claim 15, wherein the one or more resources are associated with a dedicated remote access point identifier (RAPID).

17. The method of claim 15, wherein the one or more resources comprise two or more adjacent transmission beams, each adjacent transmission beam associated with a respective SSB identifier.

18. The method of claim 15, further comprising:
receiving an indication of whether the location update message is associated with a system information request, an SSB request, or a random access channel request, wherein transmitting the location update message is based at least in part on the indication.

19. The method of claim 14, wherein the unique identifier for the UE is a temporary mobile subscriber identifier (TMSI) or an inactive radio network temporary identifier (I-RNTI) based at least in part on a radio resource control (RRC) mode of the UE.

20. The method of claim 14, wherein the on-demand system information request comprises an on-demand system information block 1 (OD-SIB1), an on-demand other system information (OD-OSI), a synchronization signal block (SSB), or a random access channel (RACH).
